(19) United States
(12) Patent Application Publication
(10) Pub. No.: US 2011/0267663 A1
(43) Pub. Date: Nov. 3, 2011

(54) HOLOGRAPHIC IMAGE PROJECTION METHOD AND HOLOGRAPHIC IMAGE PROJECTION SYSTEM

(75) Inventor: Yoshiaki Murayama, Tokyo (JP)

(73) Assignee: OLYMPUS CORPORATION, Tokyo (JP)

(21) Appl. No.: 12/968,970

(22) Filed: Dec. 15, 2010

(30) Foreign Application Priority Data
Dec. 21, 2009 (JP) 2009-289883
Dec. 21, 2009 (JP) 2009-289884
Dec. 22, 2009 (JP) 2009-291503

(51) Int. Cl. G03H 1/08

(52) U.S. Cl. 359/9

(57) ABSTRACT

Provided is a hologram-image projection method including a step of setting three-dimensional position information in a specimen for a plurality of focal points where laser light is to be focused via an objective lens; a step of performing reverse ray tracing from the individual focal points to an entrance pupil position of the objective lens by using the position information set for the individual focal points in the specimen, a refractive index of the specimen, and overall characteristic data of the objective lens, to calculate a wavefront of the laser light at the entrance pupil position from the individual focal points; a step of calculating a combined wavefront by combining the plurality of calculated wavefronts; a step of setting a phase pattern to be applied to a wavefront modulating device on the basis of the calculated combined wavefront; and a step of applying the set phase pattern to the wavefront modulating device, causing the laser light to be incident thereon, and focusing the laser light whose wavefront is modulated by the phase pattern on the specimen via the objective lens.

### TECHNICAL FIELD

The present invention relates to a hologram-image projection method and a hologram-image projection apparatus.

This application is based on Japanese Patent Applications No. 2009-289883, No. 2009-289884, and No. 2009-291503, the contents of which are incorporated herein by reference.

### BACKGROUND ART

In the related art, use of a hologram is known for simultaneously radiating light at a plurality of locations on a specimen (for example, see NPL 1).

In this method, a fluorescence image of the specimen is acquired with a fluorescence microscope or the like, a stimulus light irradiation pattern is created by identifying a plurality of sites of interest in the acquired fluorescence image where a light stimulus etc. is to be applied, and this irradiation pattern is Fourier transformed, thereby creating a hologram phase pattern. Then, by applying the created phase pattern to a wavefront modulating device and causing a substantially collimated beam of laser light guided from a light source to be incident on this wavefront modulating device, the laser light is modulated, and the modulated laser light is focused by an objective lens. Accordingly, a hologram image is projected on the specimen, so that the stimulus light is focused at a plurality of locations simultaneously.

### CITATION LIST

### Non Patent Literature

### {NPL 1}

Volodymyr Nikolenko et al, “SLM microscopy:scanless two-photon imaging and photostimulation with spatial light modulators”, Frontiers in Neural Circuits, Vol 2, Article 5, 19 Dec. 2008, p 1-15

### SUMMARY OF INVENTION

### Technical Problem

The present invention provides a hologram-image projection method and a hologram-image projection apparatus in which light can be focused simultaneously at sites of interest disposed at different positions in the depthwise direction in a specimen.

In addition, the present invention provides a hologram-image projection method and a hologram-image projection apparatus in which laser light can be focused simultaneously at a plurality of desired focal points in a specimen, even if aberrations are present in the objective lens.

Furthermore, the present invention provides a hologram-image projection apparatus in which laser light can be focused simultaneously at a plurality of desired focal points in a specimen, even when causes of various kinds of aberrations coexist.

### Solution to Problem

The present invention provides the following solutions.

A first aspect of the present invention is a hologram-image projection method including a position setting step of setting three-dimensional position information in a specimen for a plurality of focal points where laser light is to be focused via an objective lens; a wavefront calculating step of performing reverse ray tracing from the individual focal points assumed at the set positions to an entrance pupil position of the objective lens by using the position information set for the individual focal points in the specimen, a refractive index of the specimen, and overall characteristic data of the objective lens, to calculate wavefronts of the laser light at the entrance pupil position from the individual focal points; a wavefront combining step of calculating a combined wavefront by combining the plurality of wavefronts calculated for the individual focal points; a phase-pattern setting step of setting a phase pattern to be applied to a wavefront modulating device on the basis of the calculated combined wavefront; and a focusing step of applying the set phase pattern to the wavefront modulating device, causing the laser light to be incident thereon, and focusing the laser light whose wavefront is modulated by the phase pattern on the specimen via the objective lens.

A second aspect of the present invention is a hologram-image projection method including a position setting step of setting three-dimensional position information in a specimen for a plurality of focal points where laser light is to be focused via an objective lens; a virtual-image creating step of creating a virtual image in which the individual focal points are projected on a prescribed reference plane in the specimen using the set position information of the individual focal points in the specimen; a wavefront calculating step of calculating a wavefront of the laser light at an entrance pupil position of the objective lens by Fourier transforming the created virtual image using the refractive index of the specimen and overall characteristic data of the objective lens; a phase-pattern setting step of setting a phase pattern to be applied to a wavefront modulating device on the basis of the calculated wavefront; and a focusing step of applying the set phase pattern to the wavefront modulating device, causing the laser light to be incident thereon, and focusing the laser light whose wavefront is modulated by the phase pattern on the specimen via the objective lens.

A third aspect of the present invention is a hologram-image projecting apparatus including a wavefront modulating device that modulates a wavefront of laser light with a phase pattern; an objective lens that focuses the laser light modulated by the wavefront modulating device on a specimen; a position-information setting section for setting three-dimensional position information in the specimen for a plurality of focal points where the laser light is to be focused via the objective lens; a wavefront calculating section that performs reverse ray tracing from the individual focal points assumed at the set positions to an entrance pupil position of the objective lens by using the position information, inside the specimen, set for the individual focal points by the position-information setting section, a refractive index of the specimen, and overall characteristic data of the objective lens, to calculate wavefronts of the laser light at the entrance pupil position from the individual focal points; a wavefront combining section that calculates a combined wavefront by combining the plurality of wavefronts calculated by the wavefront calculating section for the individual focal points; and a phase-pattern setting section that sets the phase pattern to be applied to the wavefront modulating device on the basis of the calculated combined wavefront.

A fourth aspect of the present invention is a hologram-image projecting apparatus including a wavefront modulating device that modulates a wavefront of laser light with a phase pattern; an objective lens that focuses the laser light modulated by the wavefront modulating device on a specimen; a position-information setting section for setting three-dimensional position information, inside the specimen, for a plurality of focal points where the laser light is to be focused via the objective lens; a virtual-image creating section of creating a virtual image in which the individual focal points are projected on a prescribed reference plane in the specimen by using the position information, inside the specimen, set for the individual focal points by the position-information setting section; a wavefront calculating section that calculates a wavefront of the laser light at an entrance pupil position of the objective lens by Fourier transforming the virtual image created by the virtual-image creating section using a refractive index of the specimen and overall characteristic data of the objective lens; and a phase-pattern setting section that sets the phase pattern to be applied to the wavefront modulating device on the basis of the calculated wavefront.

A fifth aspect of the present invention is a hologram-image projection method including a position setting step of setting, for a plurality of focal points where laser light is to be focused via an objective lens, position information on a focal plane of the objective lens in the specimen; a wavefront calculating step of performing reverse ray tracing from the individual focal points assumed at the set positions to an entrance pupil position of the objective lens by using the position information, in the specimen, set for the individual focal points, a refractive index of the specimen, and lens data of individual lenses constituting the objective lens, to calculate wavefronts of the laser light at the entrance pupil position from the individual focal points; a wavefront combining step of calculating a combined wavefront by combining the plurality of wavefronts calculated for the individual focal points; a phase-pattern setting step of setting a phase pattern to be applied to a wavefront modulating device on the basis of the calculated combined wavefront; and a focusing step of applying the set phase pattern to the wavefront modulating device, causing the laser light to be incident thereon, and focusing the laser light whose wavefront is modulated by the phase pattern on the specimen via the objective lens.

A sixth aspect of the present invention is a hologram-image projection method including a position setting step of setting, for a plurality of focal points where laser light is to be focused via an objective lens, position information on a focal plane of the objective lens in the specimen; a virtual-image creating step of creating a virtual image having a plurality of spots formed at the individual focal points, by performing forward ray tracing from an entrance pupil position of the objective lens to the focal plane using the position information, in the specimen, set for the individual focal points, a refractive index of the specimen, and lens data of individual lenses constituting the objective lens; a wavefront calculating step of calculating the wavefront so that, by varying the wavefront of the laser light at the entrance pupil position of the objective lens, the diameters of the individual spots in the created virtual image are minimized; a phase-pattern setting step of setting a phase pattern to be applied to a wavefront modulating device on the basis of the calculated wavefront; and a focusing step of applying the set phase pattern to the wavefront modulating device, causing the laser light to be incident thereon, and focusing the laser light whose wavefront is modulated by the phase pattern on the specimen via the objective lens.

A seventh aspect of the present invention is a hologram-image projecting apparatus including a wavefront modulating device that modulates a wavefront of laser light with a phase pattern; an objective lens that focuses the laser light modulated by the wavefront modulating device on a specimen; a position-information setting section for setting, for a plurality of focal points on a focal plane where laser light is to be focused via an objective lens, position information on the focal plane of the objective lens in the specimen; a wavefront calculating section that performs reverse ray tracing from the individual focal points assumed at the set positions to an entrance pupil position of the objective lens by using the position information of the individual focal points set by the position-information setting section, a refractive index of the specimen, and lens data of individual lenses constituting the objective lens, to calculate wavefronts of the laser light at the entrance pupil position from the individual focal points; a wavefront combining section that calculates a combined wavefront by combining the plurality of wavefronts calculated for the individual focal points; and a phase-pattern setting section that sets the phase pattern to be applied to the wavefront modulating device on the basis of the calculated combined wavefront.

An eighth aspect of the present invention is a hologram-image projection apparatus including a laser light source; a wavefront modulating device that modulates a wavefront of laser light emitted from the laser light source with a phase pattern; an objective lens that focuses the laser light on a specimen; an incident-angle adjusting section that adjusts an incident angle of the laser light at the entrance pupil position of the objective lens; a focal-position setting section that sets the positions of a plurality of focal points where the laser light is to be focused in the specimen; a wavefront measuring section that measures wavefronts, at the entrance pupil position of the objective lens, or a position optically conjugate therewith, for return light returning from the individual focal points at the positions set by the focal-position setting section; a wavefront combining section that calculates a combined wavefront by combining the plurality of wavefronts of the return light measured by the wavefront measuring section; and a phase-pattern setting section that sets the phase pattern to be applied to the wavefront modulating device on the basis of the calculated combined wavefront and outputs the phase pattern to the wavefront modulating device.

### BRIEF DESCRIPTION OF DRAWINGS

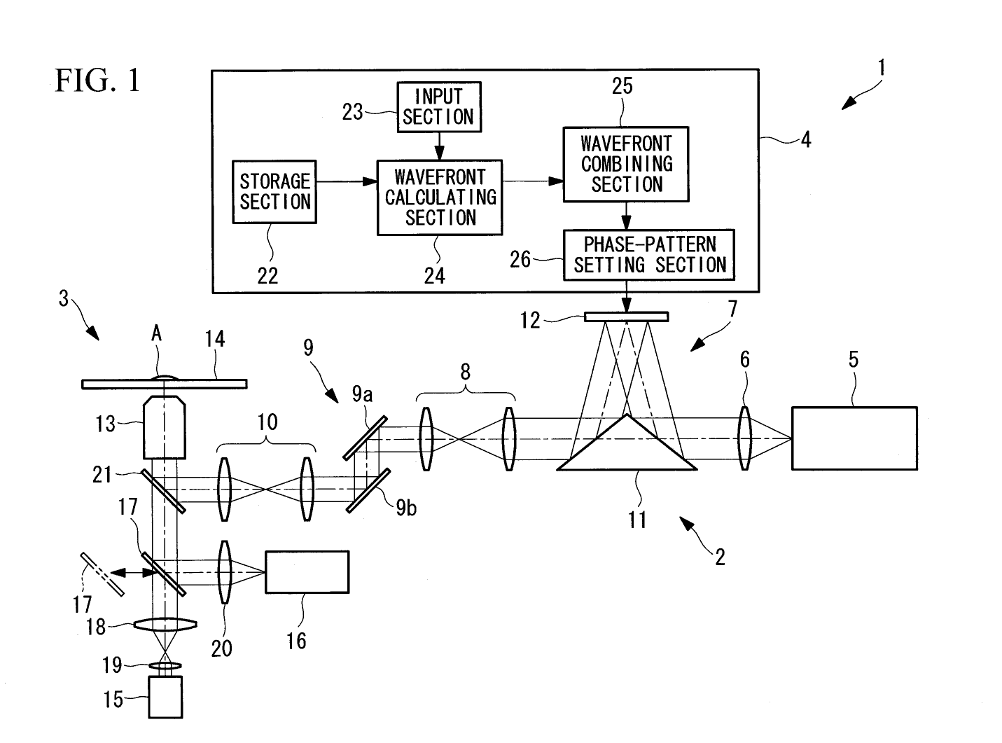

{FIG. 1} FIG. 1 is an overall configuration diagram schematically showing a hologram-image projection apparatus according to a first embodiment of the present invention.

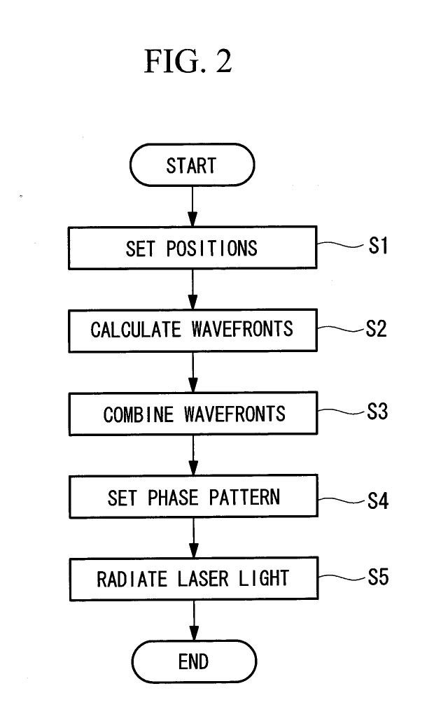

{FIG. 2} FIG. 2 is a flowchart for explaining a hologram-image projection method according to the first embodiment of the present invention, using the hologram-image projection apparatus in FIG. 1.

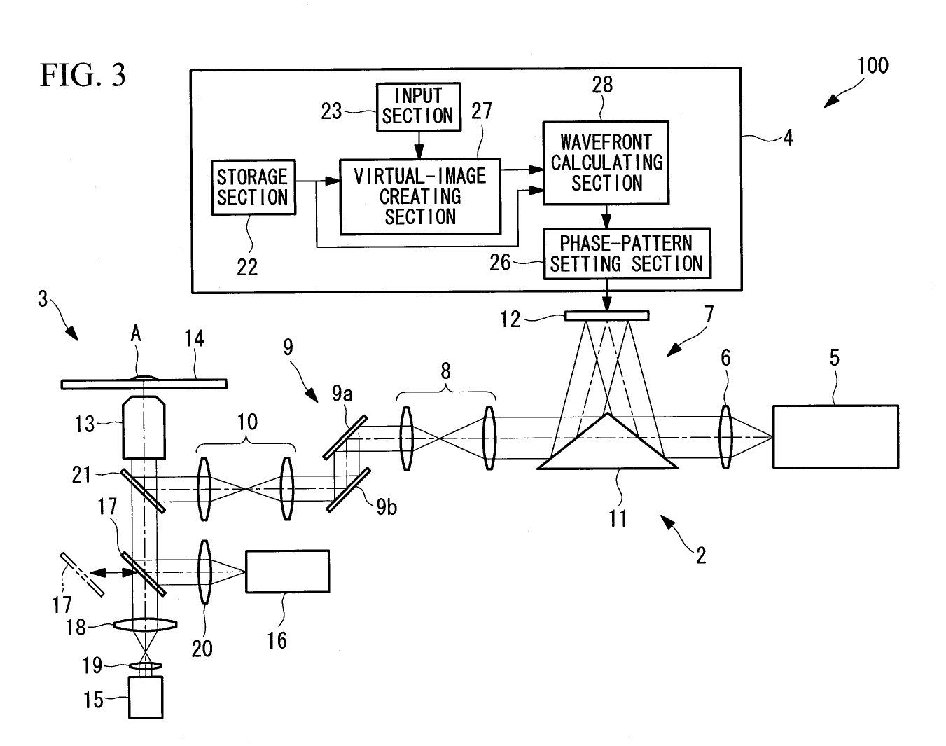

{FIG. 3} FIG. 3 is an overall configuration diagram schematically showing a hologram-image projection apparatus according to a second embodiment of the present invention.

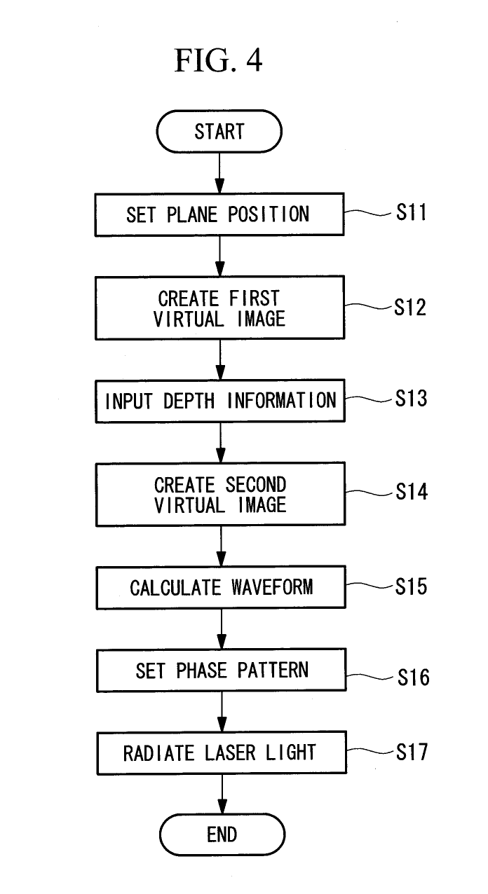

{FIG. 4} FIG. 4 is a flowchart for explaining a hologram-image projection method according to the second embodiment of the present invention, using the hologram-image projection apparatus in FIG. 3.

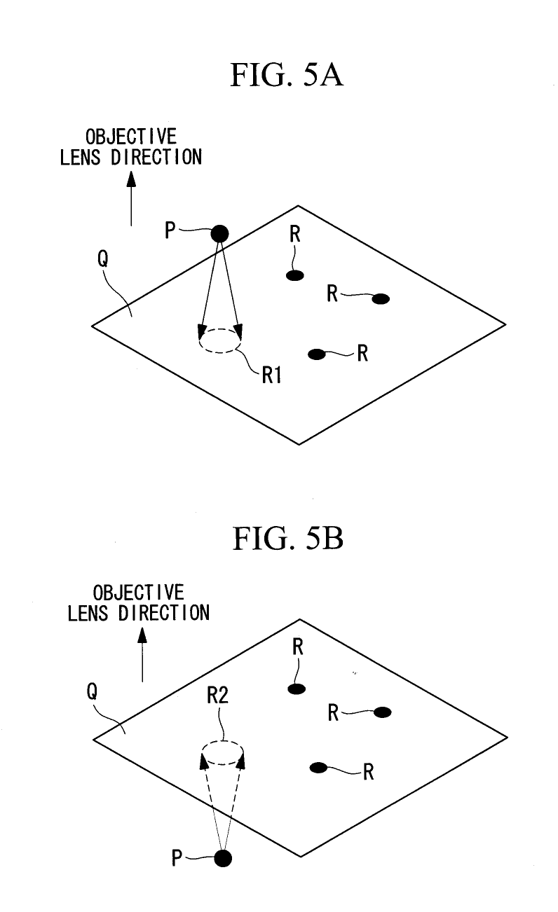

{FIG. 5A} FIG. 5A is a diagram for explaining a method of creating a second virtual image by forward ray tracing, in the hologram-image projection method in FIG. 4.

{FIG. 5B} FIG. 5B is a diagram for explaining a method of creating a second virtual image by reverse ray tracing, in the hologram-image projection method in FIG. 4.

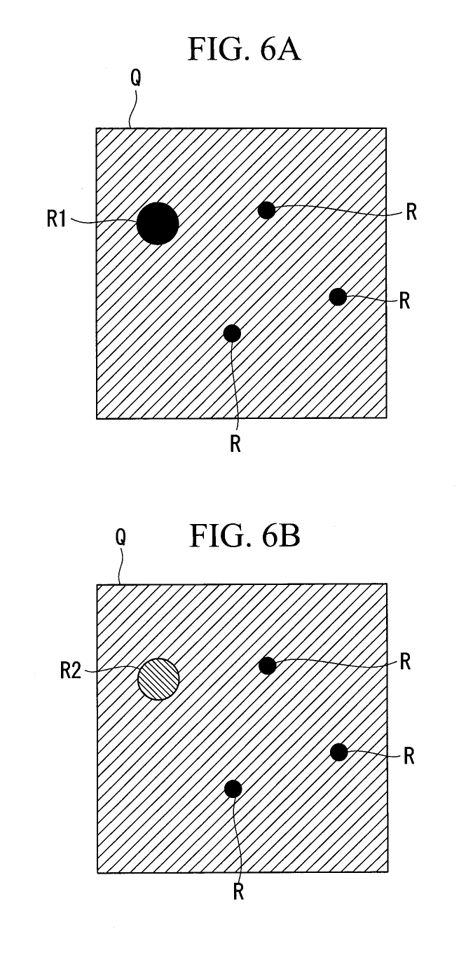

{FIG. 6A} FIG. 6A is a diagram showing a second virtual image created by forward ray tracing using the method in FIG. 5A.

{FIG. 6B} FIG. 6B is a diagram showing a second virtual image created by reverse ray tracing using the method in FIG. 5B.

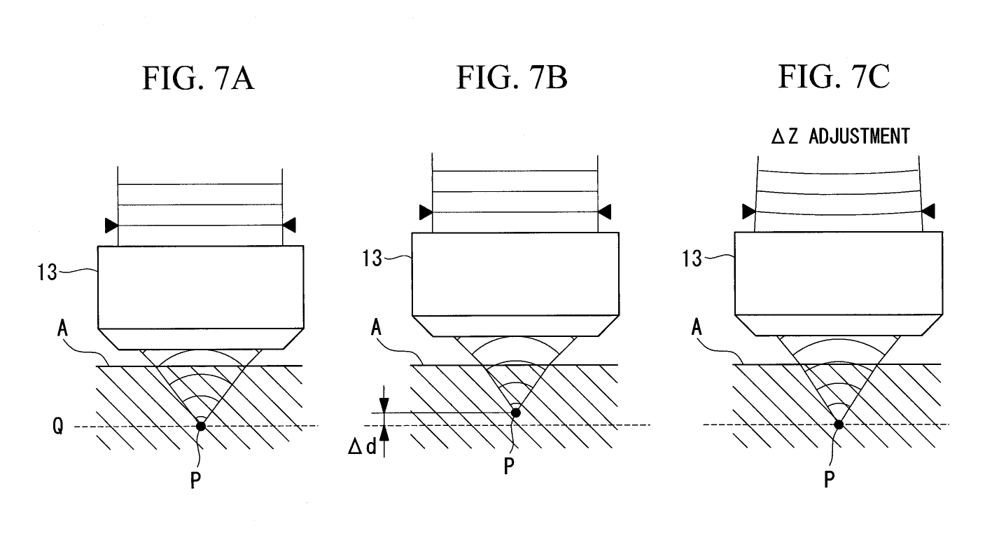

{FIG. 7A} FIG. 7A is a diagram for explaining a modification of the hologram-image projection method in FIG. 4, schematically showing a state where a reference plane is coincident with a focal plane of an objective lens.

{FIG. 7B} FIG. 7B is a diagram for explaining a modification of the hologram-image projection method in FIG. 4, schematically showing a state where the focal plane of the objective lens is shifted in the depthwise direction from the reference plane.

{FIG. 7C} FIG. 7C is a diagram for explaining a modification of the hologram-image projection method in FIG. 4, schematically showing a state where Zernike coefficients are adjusted to make the focal plane of the objective lens coincident with the reference plane.

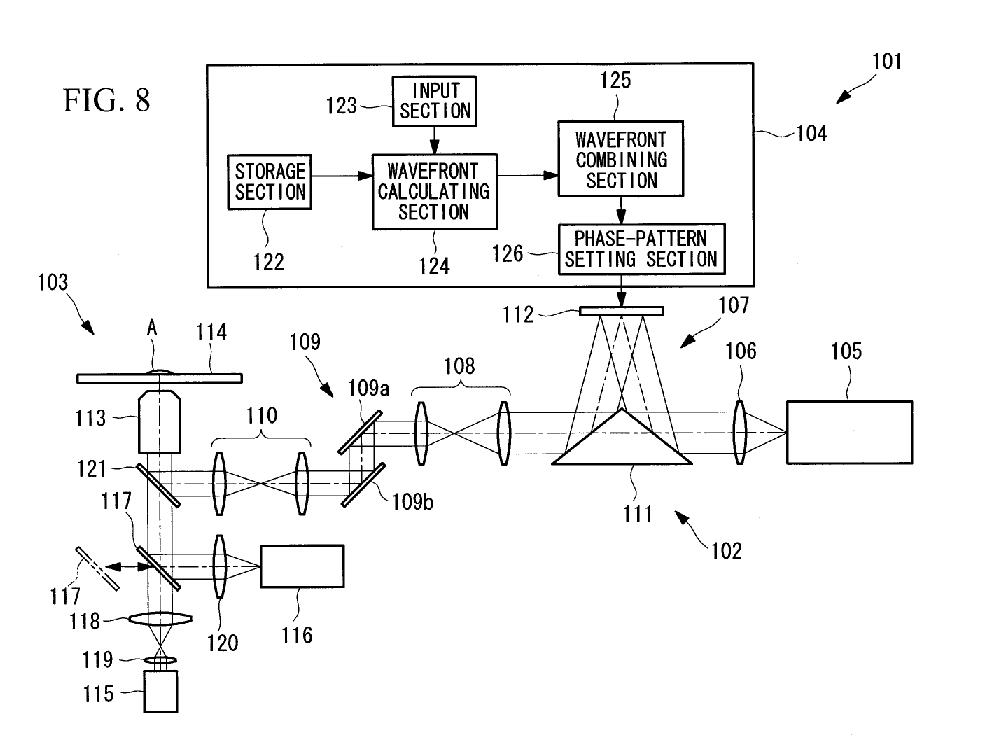

{FIG. 8} FIG. 8 is an overall configuration diagram schematically showing a hologram-image projection apparatus according to a third embodiment of the present invention.

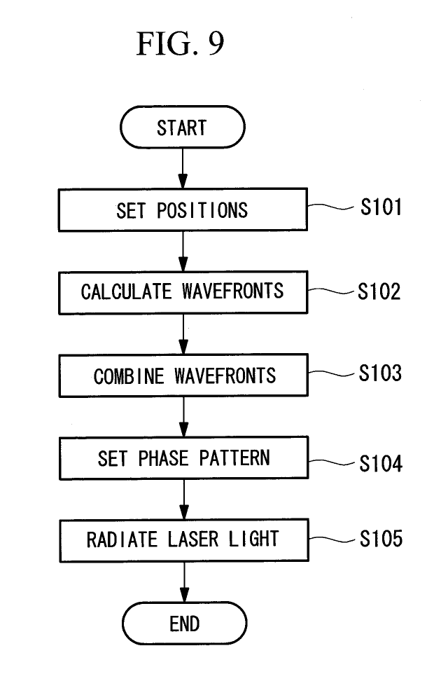

{FIG. 9} FIG. 9 is a flowchart for explaining a hologram-image projection method according to the third embodiment of the present invention, using the hologram-image projection apparatus in FIG. 8.

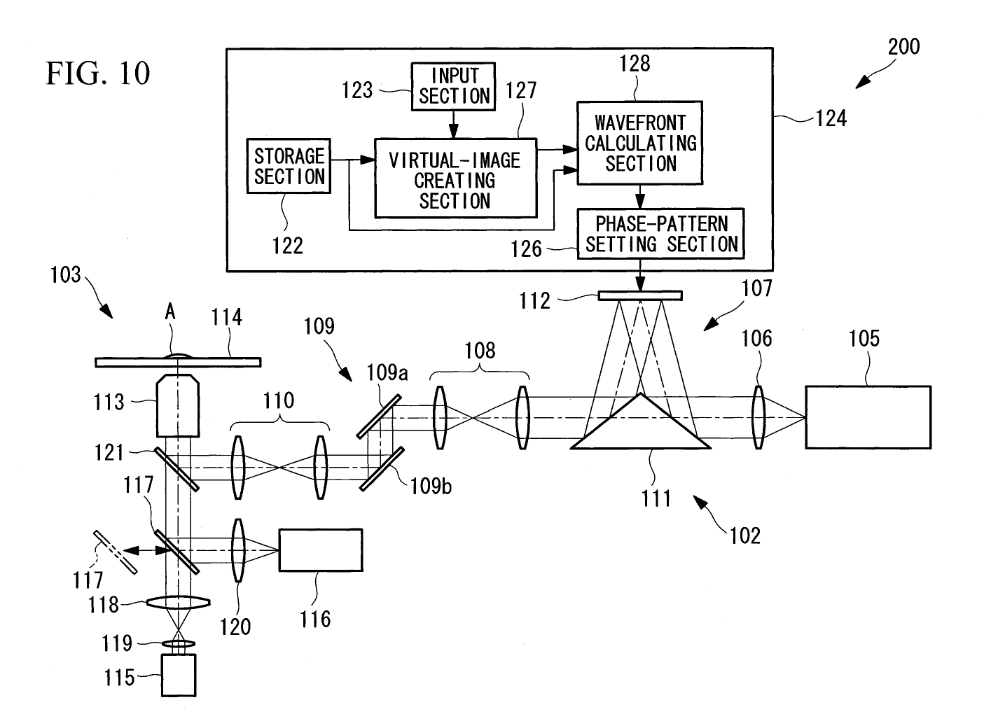

{FIG. 10} FIG. 10 is an overall configuration diagram schematically showing a hologram-image projection apparatus according to a fourth embodiment of the present invention.

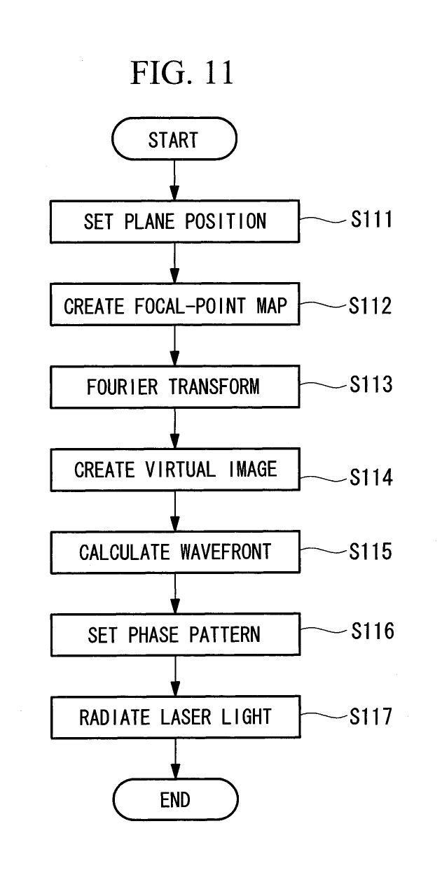

{FIG. 11} FIG. 11 is a flowchart for explaining a hologram-image projection method according to the fourth embodiment of the present invention, using the hologram-image projection apparatus in FIG. 10.

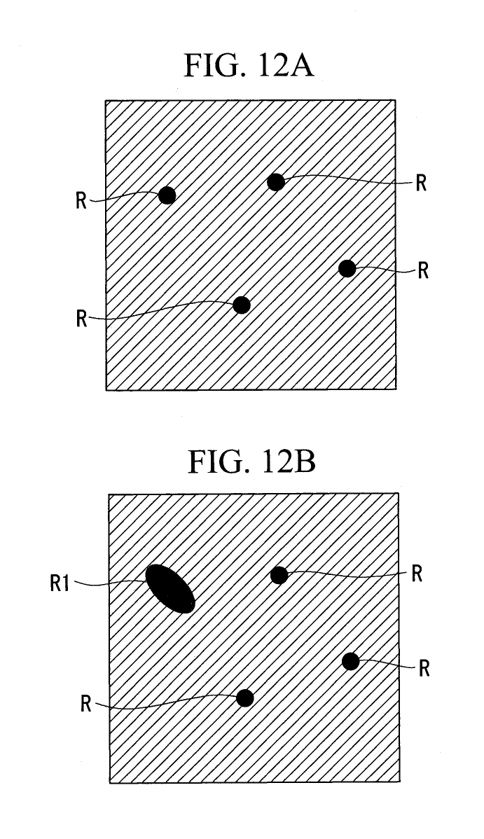

{FIG. 12A} FIG. 12A is a diagram showing a focal point map when it is assumed that the objective lens is aberration-free, in the hologram-image projection method in FIG. 11.

{FIG. 12B} FIG. 12B is a diagram showing a virtual image at the focal plane, in the hologram-image projection method in FIG. 11.

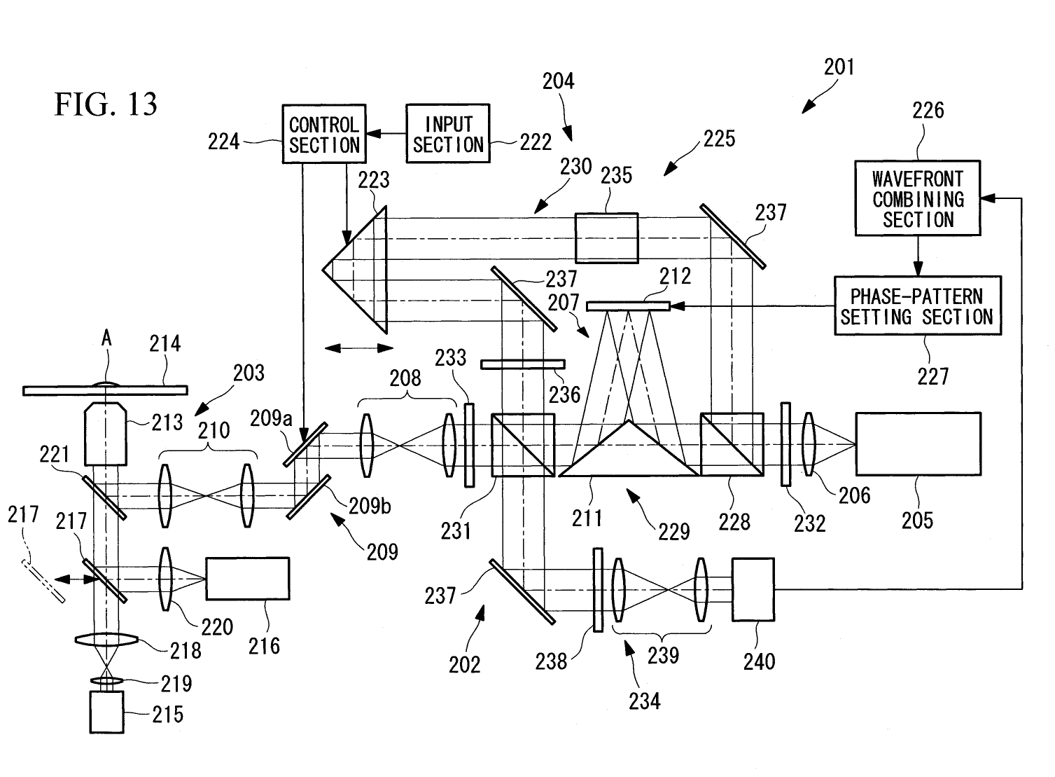

{FIG. 13} FIG. 13 is an overall configuration diagram schematically showing a hologram-image projection apparatus according to a fifth embodiment of the present invention.

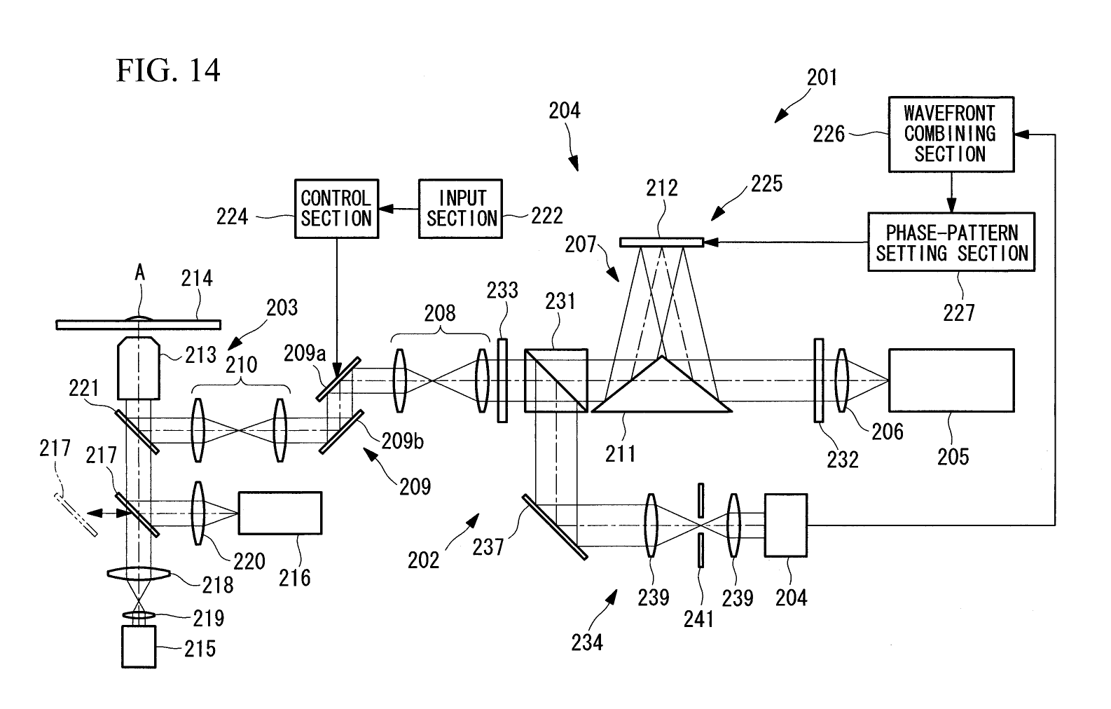

{FIG. 14} FIG. 14 is an overall configuration diagram showing a modification of the hologram-image projection apparatus in FIG. 13.

### DESCRIPTION OF EMBODIMENTS

A hologram-image projection apparatus and a hologram-image projection method according to a first embodiment of the present invention will be described below with reference to FIG. 1 and FIG. 2.

As shown in FIG. 1, a hologram-image projection apparatus 1 according to this embodiment, which is a microscope system, includes a light source apparatus 2 that emits laser light, a microscope apparatus 3 that irradiates a specimen A with laser light incident from the light source apparatus 2, and a control apparatus 4 that controls the wavefront of the laser light entering the microscope apparatus 3 from the light source apparatus 2.

The light source apparatus 2 includes a laser light source 5 that generates laser light, a collimator lens 6 that converts the laser light emitted from the laser light source 5 into a collimated beam, a wavefront modulating section 7 that modulates the wavefront of the collimated beam of laser light, relay lenses 8 and 10, and a scanner 9 that scans the laser light.

The wavefront modulating section 7 includes a prism 11 that reflects the laser light and a reflective wavefront modulating device 12 that reflects the laser light reflected by the prism 11, during which time the wavefront of the laser light is modulated by a phase pattern, and returns the laser light to the prism 11.

The laser light reflected by the prism 11 has its light path folded by the wavefront modulating device 12 so as to return to the same prism 11 and then returns to a light path along the same axis as the laser light from the laser light source 5.

The wavefront modulating device 12 is formed of a segmented MEMS mirror whose surface shape can be arbitrarily changed by the control apparatus 4, to be described later. In this case, the surface shape, which is formed of the depressions and protrusions of the individual segments in the MEMS mirror, forms a phase pattern for modulating the wavefront of the laser light. The wavefront modulating device 12 and an entrance pupil position of an objective lens 13 are disposed in an optically conjugate positional relationship.

The scanner 9 is a so-called proximity galvanometer mirror in which two galvanometer mirrors 9a and 9b that can be swiveled about axes disposed in mutually orthogonal directions are disposed in proximity to each other and can two-dimensionally scan the incident laser light.

The microscope apparatus 3 includes the objective lens 13, which focuses the laser light onto the specimen A, disposed on a stage 14, and which also collects light coming from the specimen A; a light detector 15, formed of a photomultiplier tube, for detecting the light collected by the objective lens 13; a camera 16, such as a CCD, that captures a fluorescence image in the specimen A; and a mirror 17 that is inserted in and removed from the light path so as to switch the light path to either the light detector 15 or the camera 16. Reference numerals 18 to 20 are focusing lenses, and reference numeral 21 is a dichroic mirror. The objective lens 13 has known characteristic data related to the overall system and is provided in such a manner that the distance between the objective lens 13 and the stage 14 in the optical axis direction can be varied. The overall characteristic data of the objective lens 13 includes the focal length, the numerical aperture, the entrance pupil diameter, etc. of the overall objective lens 13.

By setting the surface shape of the wavefront modulating device 12 to a flat reflective surface shape, it is possible to make laser light having a plane-wave wavefront incident at the entrance pupil position of the objective lens 13. Accordingly, it is possible to focus the laser light at the focal plane of the objective lens 13.

With the mirror 17 switched to the light detector 15 side (a position where it is removed from the light path, as indicated in the dotted lines), the laser light is emitted from the laser light source 5, and while the laser light focused at the focal plane in the specimen A is two-dimensionally scanned by driving the scanner 9, fluorescence produced at each focal position is detected by the light detector 15, thereby enabling acquisition of a two-dimensional fluorescence image of the specimen A extending over the focal plane of the objective lens 13.

Then, by acquiring a plurality of two-dimensional fluorescence images (slice images) while changing the position of the focal plane of the objective lens 13 by changing the relative distance between the objective lens 13 and the stage 14, it is possible to acquire a three-dimensional fluorescence image of the specimen A.

As shown in FIG. 1, the control apparatus 4 includes a storage section 22 that stores the overall characteristic data of the objective lens 13 and the refractive index of the specimen A; an input section (position-information setting section) 23 for setting three-dimensional position information of focal points of the laser light in the specimen A; a wavefront calculating section 24 that calculates the wavefront at the entrance pupil position of the objective lens 13, for each focal point, on the basis of the position information of each focal point set via the input section 23, as well as the overall characteristic data of the objective lens 13 and the refractive index of the specimen A stored in the storage section 22; a wavefront combining section 25 that combines the wavefronts calculated for all focal points; and a phase-pattern setting section 26 that sets a phase pattern to be applied to the wavefront modulating device 12 on the basis of the combined wavefront combined by the wavefront combining section 25.

The input section 23 is configured to set three-dimensional position information for each focal position by the user specifying a position where the laser light is desired to be focused, that is, the focal point, on a monitor (not illustrated). The depthwise-direction position information of each focal point is set in the form of relative depth information from a reference plane, when a plane at a prescribed depth in the specimen is assumed as the reference surface. This reference plane is preferably set to the focal plane of the objective lens 13 when the objective lens 13 is fixed at a prescribed position relative to the specimen A; however, it is not limited thereto.

The focal point in the specimen A may be set to an arbitrary position, or it may be set to a position that responds to a light stimulus. When it is desired to set the focal point to a position responding to a light stimulus, in order that the observer can easily specify the focal point, it is preferable to display a two-dimensional or three-dimensional image acquired by the microscope apparatus 3 on the monitor (not shown).

For each focal point that is set, the wavefront calculating section 24 calculates the wavefront corresponding to each focal point by using the position information set via the input section 23, as well as the overall characteristic data of the objective lens 13 and the refractive index of the specimen A stored in the storage section 22.

Specifically, a point light source is assumed at a position specified by the position information set for the focal point, and the wavefront is calculated by performing reverse ray tracing of the laser light from that point light source to the entrance pupil position of the objective lens 13, using the refractive index of the specimen A and the overall characteristic data of the objective lens 13. For focal points disposed on the focal plane serving as the reference plane, the wavefronts at the entrance pupil position are plane waves whose angles relative to the optical axis of the objective lens 13 differ according to the positions of the focal points in the reference plane.

The wavefront combining section 25 is configured to combine the wavefronts calculated for all focal points. In this embodiment, the wavefront combining section 25 is configured to calculate the linear summation of the wavefronts calculated for all focal points.

The phase-pattern setting section 26 sets a phase pattern to be applied to the wavefront modulating device 12 on the basis of the obtained combined wavefront at the entrance pupil position of the objective lens 13 and outputs the phase pattern to the wavefront modulating device 12. Because the wavefront modulating device 12 is in a conjugate relationship with the entrance pupil of the objective lens 13, the phase pattern applied to the wavefront modulating device 12 is identical to the combined wavefront at the entrance pupil position of the objective lens 13 or is a pattern formed by phase-wrapping processing. In phase-wrapping processing, when the range of phase modulation at the wavefront modulating device 12 is set to 2 nπ (n is an integer), for portions in the combined wavefront at the entrance pupil position of the objective lens 13 that have a phase difference exceeding 2 nπ, 2 nπ is subtracted from that phase difference. With the segmented MEMS mirror in this embodiment, because the range of phase modulation is normally set to a range of 2 nπ, phase-wrapping processing is performed as required.

In this way, the wavefront modulating device 12 is adjusted so as to assume a surface shape matching the input phase pattern. Thus, the laser light reflected at the wavefront modulating device 12 is modulated at the surface of the wavefront modulating device 12 to have the same wavefront as the obtained combined wavefront at the entrance pupil position of the objective lens 13. Therefore, by focusing such laser light with the objective lens 13, it is simultaneously focused at the individual set focal points while keeping the objective lens 13 fixed.

A hologram-image projection method for projecting a hologram image like one in which laser light is focused simultaneously at a plurality of positions at different depths in the specimen A by using the thus-configured hologram-image projection apparatus 1 according to this embodiment will now be described.

First, as shown in FIG. 2, position information for each focal point is set via the input section 23 (step S1).

Here, when the focal point is set to a position that responds to a light stimulus in the specimen A, the wavefront modulating device 12 is set to a phase pattern forming a flat reflective surface shape based on the output from the control apparatus 4. In the microscope apparatus 3, the mirror 17 is retracted from the light path. Then, laser light is emitted from the laser light source 5, and the laser light is two-dimensionally scanned by the scanner 9.

The laser light emitted from the laser light source 5 propagates along the light path without changing its wavefront and, after being two-dimensionally scanned by the scanner 9, is reflected by the dichroic mirror 21 to enter the objective lens 13 and is focused at the focal plane in the specimen A. Fluorescence is produced at the focal position of the laser light, and the fluorescence produced is collected by the objective lens 13, is transmitted through the dichroic mirror 21, is focused by the focusing lenses 18 and 19, and is detected by the light detector 15.

Because the fluorescence is produced only in an extremely shallow region in the vicinity of the focal plane of the objective lens 13, by storing the intensity of the fluorescence detected by the light detector 15 and the scanning position of the laser light scanned by the scanner 9 in association with each other, it is possible to obtain a fluorescence image (slice image) of the specimen A extending over the focal plane. By obtaining a plurality of slice images while moving the objective lens 13 and the specimen A relative to each other in the optical axis direction, it is possible to obtain a three-dimensional fluorescence image.

In the three-dimensional fluorescence image displayed on the monitor (not shown), the observer specifies the positions of the focal points where the laser light should be focused. For example, if the specimen A is a nerve cell whose behavior is to be observed when stimulated with laser light, the focal points where the stimulus is to be applied are distributed three-dimensionally. In this case, the observer sets the three-dimensional position information of the focal points by specifying all focal points.

By fixing the objective lens 13 relative to the specimen A, the focal plane of the objective lens 13 is fixed relative to the specimen. Regarding the depth information in the position information of the focal points, the relative distance in the depthwise direction from the reference plane, when a plane at a prescribed depth in the specimen A is defined as the reference plane, is set. This reference plane is set, for example, to the focal plane of the objective lens 13.

On the other hand, when the focal plane is set to an arbitrary position in the specimen A, it is not necessary to acquire such a three-dimensional fluorescence image.

Next, reverse ray tracing is performed in the wavefront calculating section 24 using the position information set via the input section 23, as well as the overall characteristic data of the objective lens 13 and the refractive index of the specimen A stored in the storage section 22, and the wavefront at the entrance pupil position of the objective lens 13 is calculated for the laser light emitted from the point light source assumed at each focal position (step S2).

Once the wavefronts at the entrance pupil position of the objective lens 13 are calculated for all focal points, a linear summation of the wavefronts is calculated by the wavefront combining section 25, thus generating a combined wavefront (step S3). The combined wavefront thus generated is input to the phase-pattern setting section 26, and the phase pattern to be applied to the wavefront modulating device 12 is set to be identical to the combined wavefront at the entrance pupil position of the objective lens 13 or a pattern formed by phase-wrapping processing (step S4). Then, the phase pattern set by the phase-pattern setting section 26 is output to the wavefront modulating device 12.

This completes the preparations for performing observation while applying a light stimulus to the specimen A.

In this state, the microscope apparatus 3 is configured so that the mirror 17 is inserted into the light path (disposed at a position indicated by the solid lines in the figure), and the fluorescence collected by the objective lens 13 is focused by the focusing lens 20 and is acquired by the camera 16. Then, with the scanner 9 stopped at the origin, when the laser light emitted from the laser light source 5 is introduced into the wavefront modulating section 7, the wavefront of the laser light is modulated according to the phase pattern displayed on the wavefront modulating device 12. The modulated laser light passes through the relay lenses 8, the scanner 9, and the relay lenses 10, is reflected by the dichroic mirror 21, and enters the entrance pupil of the objective lens 13 (step S5).

Because the entrance pupil position of the objective lens 13 is located at a position that is optically conjugate with the wavefront modulating device 12, the laser light incident at the entrance pupil position has a wavefront identical to the wavefront at the instant it is modulated by the wavefront modulating device 12.

Then, by focusing this laser light with the objective lens 13, a three-dimensional hologram image like one in which laser light is focused simultaneously at a plurality of focal points located at different positions in the depthwise direction can be projected inside the specimen A.

By simultaneously irradiating a plurality of specified focal points with the laser light, in the state where a stimulus is applied to the specimen A, the fluorescence emitted from the specimen A is collected by the objective lens 13, is transmitted through the dichroic mirror 21, is reflected by the mirror 17, is focused by the focusing lens 20, and is acquired by the camera 16. Thus, it is possible to obtain a fluorescence image of the specimen A while a light stimulus is applied thereto.

Thus, with the hologram-image projection apparatus 1 and the hologram-image projection method according to this embodiment, it is possible to focus laser light simultaneously at a plurality of sites of interest located at different positions in the depthwise direction of the specimen A. Consequently, when the focal points are set at positions responding to a light stimulus in the specimen A, an advantage is afforded in that it is possible to correctly observe the behavior of the specimen occurring directly after the light stimulus without any time delay.

Note that, in this embodiment, although wavefront combining is performed in the wavefront combining section 25 by calculating a linear summation of the wavefronts, instead of this, it may be performed by arraying divided regions of a plurality of wavefronts calculated for the individual focal points with a ratio equal to the reciprocal of the total number of focal points.

More specifically, if n is the total number of focal points, a linear summation of the wavefronts calculated for the individual focal points is not calculated, but the region on the wavefront modulating device 12 is divided, and any of the plurality of focal points are associated with the individual divided regions. The associating process here is preferably performed so that the regions associated with the individual focal points are periodically distributed with a ratio equal to the reciprocal of the total number of focal points, n. Also, the distribution of the regions associated with the individual focal points may be in the form of a mosaic or may be in form of concentric circles. Assuming this kind of association, in the wavefronts of the individual focal points which are calculated in advance, wavefront elements of portions of the wavefront modulating device 12 overlapping the associated regions are extracted, and the wavefronts are combined by arraying the extracted wavefront elements over the entire region. The phase pattern to be applied to the wavefront modulating device 12 is set on the basis of the combined wavefront obtained in this way.

With the hologram-image projection method of this embodiment, the three-dimensional position information of each of the focal points three-dimensionally located at different positions in the specimen A is set in the position setting step S1, and in the wavefront calculating step S2, reverse ray tracing is performed from each focal point to the entrance pupil position of the objective lens 13. By combining the plurality of wavefronts calculated in the wavefront calculating step S2 in the wavefront combining step S3, a combined wavefront serving as the wavefront required to be incident at the entrance pupil position of the objective lens 13 to simultaneously focus the laser light at different three-dimensional positions is obtained by calculation. Then, a phase pattern is applied to the wavefront modulating device 12 so that the wavefront of the laser light incident on the wavefront modulating device 12 is modulated to a wavefront identical to the obtained combined wavefront. Accordingly, a hologram image like one in which laser light is focused simultaneously at focal points disposed three-dimensionally at different depth positions can be projected inside the specimen A.

With the hologram-image projection apparatus 1 of this embodiment, once the three-dimensional position information of the individual focal points is set via the input section 23, reverse ray tracing from the focal points to the entrance pupil position of the objective lens 13 is performed by the wavefront calculating section 24 using the set position information, as well as the refractive index of the specimen A and the overall characteristic data of the objective lens 13. Accordingly, the wavefront at the entrance pupil position of the objective lens 13 is calculated for the laser light coming from each focal point. Then, the plurality of wavefronts obtained for the individual focal points are combined in the wavefront combining section 25 to obtain the combined wavefront. The phase pattern is set in the phase-pattern setting section 26 on the basis of the combined wavefront obtained in this way. Accordingly, merely by radiating the laser light on the wavefront modulating device 12 to which the set phase pattern has been applied, a hologram image that causes the laser light focused by the objective lens 13 to be simultaneously focused at a plurality of focal points disposed at different positions three-dimensionally can be projected inside the specimen.

A hologram-image projection apparatus and a hologram-image projection method according to a second embodiment of the present invention will be described below with reference to FIGS. 3 to 6 and FIGS. 7A to 7C.

In this embodiment, elements having the same configuration as those in the hologram-image projection apparatus and the hologram-image projection method according to the above-described first embodiment are assigned the same reference numerals, and a description thereof is omitted.

In the first embodiment, the wavefront is generated by performing reverse ray tracing from each of the set focal points to the entrance pupil position of the objective lens 13. In this embodiment, however, instead of this, a spot image is obtained by performing forward ray tracing from each focal point to a prescribed reference plane, and the wavefront is generated by transforming this image.

As shown in FIG. 3, a hologram-image projection apparatus 100 according to this embodiment differs from the first embodiment in the configuration of the control apparatus 4. Specifically, the control apparatus 4 includes a storage section 22 that stores the overall characteristic data of an objective lens 13 and the refractive index of a specimen A; an input section (position-information setting section) 23 for inputting three-dimensional position information of the focal point of the laser light in the specimen A; a virtual-image creating section 27 that creates a virtual image formed by projecting each focal point on a prescribed reference plane on the basis of the overall characteristic data of the objective lens 13 and the refractive index of the specimen A stored in the storage section 22; a wavefront calculating section 28 that calculates the wavefront at the entrance pupil position of the objective lens 13 by Fourier transforming the created virtual image; and a phase-pattern setting section 26 that sets the phase pattern to be applied to a wavefront modulating device 12 on the basis of the wavefront calculated by the wavefront calculating section 28.

Here, the wavefront calculating section 28 Fourier transforms the virtual image created by the virtual-image creating section 27 using the overall characteristic data of the objective lens 13 and the refractive index of the specimen A stored in the storage section 22.

A hologram-image projection method for projecting a hologram image like one in which laser light is focused simultaneously at a plurality of positions at different depths in the specimen A by using the thus-configured hologram-image projection apparatus 100 according to this embodiment will be described.

First, as shown in FIG. 4, plane position information of each focal point in the reference plane is set at the input section 23 (step S11).

Next, on the basis of the plane position information of each focal point in the reference plane set via the input section 23, a first virtual image in which it is assumed that all focal points disposed at different positions in the depthwise direction relative to the reference plane form a spot by focusing light on the reference plane is created at the virtual-image creating section 27 (step S12). The first virtual image is created by specifying each focal point using only a single slice image acquired at an arbitrary reference plane. Although this reference plane is preferably set at the focal plane of the objective lens 13, it is not limited thereto. Thus, because no depth information of the actual focal points is used in creating the first virtual image, the first virtual image does not reflect a real spot image, but is a spot image in which it is assumed that all focal points are at the reference plane.

Next, for each of the focal points, depth information from the reference plane is input via the input section 23 (step S13).

Then, a second virtual image at the reference plane is created by performing correction of spots corresponding to the focal points focused at different positions from the reference plane to add the depth information set via the input section 23 (step S14). After this, the created second virtual image is Fourier transformed, and a wavefront, at the entrance pupil position of the objective lens 13, that enables projection of the spots in the second virtual image, is calculated (step S15). Then, the calculated wavefront is input to the phase-pattern setting section 26, and the phase pattern applied to the wavefront modulating device 12 is set to be identical to the wavefront at the entrance pupil position of the objective lens 13 or to a pattern obtained by phase-wrapping processing (step S16). Then, the phase pattern set by the phase-pattern setting section 26 is output to the wavefront modulating device 12. In this state, when laser light is emitted from the laser light source 5 and enters the wavefront modulating section 7, the wavefront of the laser light is modulated according to the phase pattern on the wavefront modulating device 12. The modulated laser light passes through the relay lenses 8, the scanner 9, the relay lenses 10, and the dichroic mirror 21 and is focused onto the specimen by the objective lens 13 to irradiate it (step S17).

In the method of creating the second virtual image, a point light source is assumed at a focal point P that is not located on the reference plane Q, and by performing forward ray tracing from that point source to the reference plane Q, as shown in FIG. 5A, or by performing reverse ray tracing, as shown in FIG. 5B, a wavefront that forms a new spot R1 or R2 on the reference plane Q is calculated. For the obtained wavefront, at the spot R1 in the case of forward ray tracing, shown in FIG. 6A, and the spot R2 in the case of reverse ray tracing, shown in FIG. 6B, depth information contained in the wavefront is inverted. Correction is applied to the spots R on the reference plane Q.

In another method of creating the second virtual image, as shown in FIG. 7A, the objective lens 13 is fixed relative to the specimen A, the laser light is focused on the reference plane Q, and a fluorescence image is acquired. Next, as shown in FIG. 7B, the objective lens 13 is moved by distance Ad in the optical axis direction. Accordingly, because the focal point P is shifted from the reference plane Q, the intensity of the fluorescence image varies. In this state, as shown in FIG. 7C, the intensity of the fluorescence image is observed when the coefficient Z₄ in a fourth-order Zernike polynomial, which is vector information representing the aberrations at the focal plane Q of the objective lens 13, is continuously varied, and the value of the coefficient Z₄ that yields the same intensity as the initial intensity is determined. When the change in the coefficient Z₄ at this time is ΔZ, the proportionality coefficient K=ΔZ/Δd is calculated. Accordingly, the Zernike coefficient Z₄ and a wavefront W at the entrance pupil position (the position indicated by the black triangles in FIGS. 7A, 7B, and 7C) of the objective lens 13 are calculated on the basis of the calculated proportionality coefficient K and the depth information from the reference plane Q to the focal point P.

A cylindrical function w(r, θ) giving the shape of the wavefront, which is a Zernike polynomial, is shown in the following formula:

$$w ( r , θ ) = Z 1 + Z 2 \cdot ρcos θ + Z 3 \cdot ρsinθ + Z 4 \cdot ( 2 {ρ}^{2} - 1 ) + Z 5 \cdot {ρ}^{2} cos 2 θ + Z 6 \cdot {ρ}^{2} sin 2 θ + Z 7 \cdot ( 3 {ρ}^{2} - 2 ) ρ cos θ + Z 8 \cdot ( 3 {ρ}^{2} - 2 ) ρsin θ …$$

Here, ρ is the distance from the center of the pupil normalized by the radius from the center of the entrance pupil of the objective lens 13, and θ is the angle relative to a prescribed reference line in polar coordinates in the plane of the wavefront modulating device 12 or the entrance pupil plane of the objective lens 13. Zn are Zernike coefficients.

By using the fourth term, which is a defocus term, in the Zernike polynomial, the wavefront W at the entrance pupil position of the objective lens 13 can be expressed by

W=Z₄×(2ρ²−1).

The Zernike coefficient Z₄ can be expressed by

Z₄=K×d.

Here, d is the depth information from the reference plane Q to the focal point P, set via the input section 23.

After the wavefront W is obtained in this way, the wavefront at the reference plane Q when laser light with this wavefront is made incident at the entrance pupil position of the objective lens 13 is determined and is corrected by substituting the corresponding spot in the first virtual image with this wavefront. The second virtual image is created by repeating the same operation for all focal points P shifted in the depthwise direction relative to the reference plane Q.

In this embodiment, after creating the first virtual image for when it is assumed that all focal points are focused on the reference plane, the second virtual image corrected on the basis of the depth information is created. Instead of this, however, a virtual image in which the individual focal points are projected on a prescribed reference image on the basis of three-dimensional position information of the focal points may be created in one step. In this case, the three-dimensional position information of the individual focal points is set via the input section 23. Also, the virtual-image creating section 27 creates a virtual image in which the individual focal points are projected on a prescribed reference plane on the basis of this three-dimensional position information, as well as the overall characteristic data of the objective lens 13 and the refractive index of the specimen stored in the storage section 22.

With the hologram-image projection method of this embodiment, the three-dimensional position information of the individual focal points three-dimensionally disposed at different positions in the specimen A is set in the position setting steps S11 and S13, and a virtual image in which a plurality of focal points to be formed by focusing the laser light via the objective lens 13 are projected on a prescribed reference plane is created in the virtual-image creating steps S12 and S14. In the wavefront calculating step S15, the wavefront at the entrance pupil position of the objective lens 13 is calculated by Fourier transforming the virtual image. Then, the phase pattern to be applied to the wavefront modulating device 12 is set in the phase-pattern setting step S16, and in a focusing step, the set phase pattern is applied to the wavefront modulating device 12, and the laser light is made incident on the wavefront modulating device 12, thereby focusing the laser light, whose wavefront has been modulated by the phase pattern, on the specimen A via the objective lens 13. Accordingly, a hologram image in which the laser light is focused simultaneously at a plurality of focal points disposed three-dimensionally in the specimen A can be projected in the specimen A.

In addition, of the spots in the first virtual image, in which all spots are focused at the prescribed reference plane, for spots corresponding to focal points that are not focused at the reference plane, because the phase pattern is generated from the second virtual image created by correcting the spots on the basis of the set depth information, merely by radiating a collimated beam of laser light onto the wavefront modulating device 12 to which this phase pattern is applied, the laser light modulated by the wavefront modulating device 12 can be focused even at depth positions in the specimen that differ from the reference plane. Accordingly, it is possible to focus the laser light simultaneously at a plurality of different focal points in the depthwise direction.

By replacing the spots in the first virtual image with spots obtained by forward ray tracing or reverse ray tracing of the laser light focused at each focal point up to the reference plane, it is possible to more easily calculate the second virtual image that forms spots such that they are focused at different positions in the depthwise direction inside the specimen.

In addition, at the position of the objective lens 13 for focusing the laser light at the reference plane, it is possible to obtain vector information representing the aberrations at the focal plane of the objective lens 13 necessary for focusing the laser light at depth positions that differ from the reference plane by multiplying the depth information representing the actual distance between the focal points P and the reference plane Q by the calculated proportionality coefficient K. By creating the second virtual image in which the spots are corrected on the basis of this vector information, it is possible to focus the laser light simultaneously at a plurality of different focal points in the depthwise direction while keeping the objective lens 13 fixed.

With the hologram-image projection apparatus 100 of this embodiment, when the three-dimensional position information of the individual focal points is set via the input section 23, a virtual image in which the individual focal points are projected on the prescribed reference plane inside the specimen A is created by the virtual-image creating section 27 by using this set position information, and the wavefront at the entrance pupil position of the objective lens 13 is calculated by the wavefront calculating section by Fourier transforming the virtual image using the refractive index of the specimen A and the overall characteristic data of the objective lens 13. Then, the phase pattern to be applied to the wavefront modulating device 12 is set on the basis of the calculated wavefront. Accordingly, simply by radiating laser light onto the wavefront modulating device 12 to which the set phase pattern has been applied, a hologram image in which the laser light focused by the objective lens 13 is simultaneously focused at a plurality of focal points disposed at different three-dimensional positions can be projected inside the specimen.

In the first and second embodiments described above, although a segmented MEMS mirror whose surface shape can be varied has been illustrated as an example of the wavefront modulating device 12, instead of this, any other type of wavefront modulating device 12 can be used, for example, a liquid crystal device, a deformable mirror, or the like. In the case of a liquid crystal device, the refractive index distribution due to the alignment of the liquid crystal molecules constitutes the phase pattern, and in the case of a deformable mirror, the surface shape thereof constitutes the phase pattern.

A hologram-image projection apparatus and a hologram-image projection method according to a third embodiment of the present invention will be described below with reference to FIGS. 8 and 9.

As show in FIG. 8, a hologram-image projection apparatus 101 according to this embodiment, which is a microscope system, includes a light source apparatus 102 that emits laser light, a microscope apparatus 103 that irradiates a specimen A with the laser light incident from the light source apparatus 102, and a control apparatus 104 that adjusts the laser light entering the microscope apparatus 103 from the light source apparatus 102.

The light source apparatus 102 includes a laser light source 105 that emits laser light, a collimator lens 106 that converts the laser light emitted from the laser light source 105 into a collimated beam, a wavefront modulating section 107 that modulates the wavefront of the collimated beam of laser light, relay lenses 108 and 110, and a scanner 109 that scans the laser light.

The wavefront modulating section 107 includes a prism 111 that reflects the laser light and a reflective wavefront modulating device 112 that reflects the laser light reflected by the prism 111, during which time the wavefront of the laser light is modulated by a phase pattern, and returns the modulated laser light to the prism 111.

The laser light reflected by the prism 111 has its light path folded at the wavefront modulating device 112 so as to return to the same prism 111, and then returns to a light path on the same axis as the laser light from the laser light source 105.

The wavefront modulating device 112 is formed of a segmented MEMS mirror whose surface shape can be arbitrarily changed by the control apparatus 104, described later. In this case, the surface shape formed by the indentations and protrusions of the individual segments of the MEMS mirror constitutes the phase pattern for modulating the wavefront of the laser light. The wavefront modulating device 112 and the entrance pupil position of the objective lens 113 are disposed in an optically conjugate positional relationship.

The scanner 109 is a so-called proximity galvanometer mirror in which two galvanometer mirrors 109a and 109b that can be swiveled about axes disposed in mutually intersecting directions are placed in close proximity to each other, so that the incident laser light can be scanned two-dimensionally.

The microscope apparatus 103 includes the objective lens 113, which focuses the laser light onto the specimen A, disposed on a stage 114, and also collects light coming from the specimen A; a light detector 115, formed of a photomultiplier tube, for detecting fluorescence collected by the objective lens 113; a camera 116, such as a CCD, that captures a fluorescence image in the specimen A; and a mirror 117 that is inserted in and removed from the light path so as to switch the light path to either the light detector 115 or the camera 116. Reference numerals 118 to 120 are focusing lenses, and reference numeral 121 is a dichroic mirror. The objective lens 113 has known lens data for the individual lenses constituting the objective optical system and is provided in such a manner that the distance between the objective lens 113 and the stage 114 in the optical axis direction can be varied.

By setting the surface shape of the wavefront modulating device 112 to a flat reflective surface shape, it is possible to make laser light having a plane-wave wavefront incident at the entrance pupil position of the objective lens 113. Accordingly, it is possible to focus the laser light at the focal plane of the objective lens 113.

With the mirror 117 switched to the light detector 115 side (a position where it is removed from the light path, as indicated in the dotted lines), the laser light is emitted from the laser light source 105, and while the laser light focused at the focal plane in the specimen A is two-dimensionally scanned by driving the scanner 109, fluorescence produced at each focal position is detected by the light detector 115, thereby enabling acquisition of a two-dimensional fluorescence image of the specimen A extending over the focal plane of the objective lens 113.

As shown in FIG. 8, the control apparatus 104 includes a storage section 122 that stores the lens data of the objective lens 113; an input section (position-information setting section) 123 for setting position information of focal points of the laser light in the specimen A; a wavefront calculating section 124 that calculates the wavefront at the entrance pupil position of the objective lens 113 corresponding to each focal point on the basis of the position information of each focal point set via the input section 123, as well as the lens data of each lens constituting the objective lens 113 and the refractive index of the specimen A stored in the storage section 122; a wavefront combining section 125 that combines a plurality of wavefronts calculated for all focal points; and a phase-pattern setting section 126 that sets a phase pattern to be applied to the wavefront modulating device 112 on the basis of the combined wavefront combined by the wavefront combining section 125.

The input section 123 is configured to set two-dimensional position information for each focal point by the user specifying a position where the laser light is desired to be focused, that is, the focal point, on a monitor (not illustrated). The focal point in the specimen A may be set to an arbitrary position, or it may be set to a position that responds to a light stimulus. When it is desired to set the focal point to a position that responds to a light stimulus, in order that the user can easily specify the focal point, it is preferable to display a two-dimensional image acquired by the microscope apparatus 103 on the monitor (not shown).

For each focal point that is set, the wavefront calculating section 124 calculates the wavefront corresponding to each focal point by using the position information set via the input section 123 and the lens data of the objective lens 113 stored in the storage section 122.

Specifically, a point light source is assumed at a position specified by the position information set for the focal point, and the wavefront is calculated by performing reverse ray tracing of the laser light from that point light source to the entrance pupil position of the objective lens 113, using the lens data of the objective lens 113.

The wavefront combining section 125 is configured to combine the wavefronts calculated for all focal points. In this embodiment, the wavefront combining section 125 is configured to calculate the linear summation of the wavefronts calculated for all focal points.

The phase-pattern setting section 126 sets a phase pattern to be applied to the wavefront modulating device 112 on the basis of the combined wavefront obtained at the entrance pupil position of the objective lens 113 and outputs the phase pattern to the wavefront modulating device 112. Because the wavefront modulating device 112 is in a conjugate relationship with the entrance pupil of the objective lens 113, the phase pattern applied to the wavefront modulating device 112 is identical to the combined wavefront at the entrance pupil position of the objective lens 113 or is a pattern formed by phase-wrapping processing. In phase-wrapping processing, when the range of phase modulation at the wavefront modulating device 112 is set to 2 nπ (n is an integer), for portions in the combined wavefront at the entrance pupil position of the objective lens 113 that have a phase difference exceeding 2 nπ, 2 nπ is subtracted from that phase difference. With the segmented MEMS mirror in this embodiment, because the range of phase modulation is normally set to a range of 2 nπ, phase-wrapping processing is performed as required.

In this way, the wavefront modulating device 112 is adjusted so as to assume a surface shape matching the input phase pattern. Thus, the laser light reflected at the wavefront modulating device 112 is modulated at the surface of the wavefront modulating device 112 to have the same wavefront as the combined wavefront obtained at the entrance pupil position of the objective lens 113. Therefore, by focusing this laser light with the objective lens 113, it is simultaneously focused at the individual set focal points while keeping the objective lens 113 fixed.

A hologram-image projection method for projecting a hologram image like one in which laser light is focused simultaneously at a plurality of different positions in the specimen A by using the thus-configured hologram-image projection apparatus 101 according to this embodiment will now be described.

First, as shown in FIG. 9, position information for each focal point is set via the input section 123 (step S101).

Here, when the focal point is set to a position that responds to a light stimulus in the specimen A, the wavefront modulating device 112 is set to a phase pattern forming a flat reflective surface shape based on the output from the control apparatus 104. In the microscope apparatus 103, the mirror 117 is retracted from the light path. Then, laser light is emitted from the laser light source 105, and the laser light is two-dimensionally scanned by the scanner 109.

The laser light emitted from the laser light source 105 propagates along the light path without changing its wavefront and, after being two-dimensionally scanned by the scanner 109, is reflected by the dichroic mirror 121 to enter the objective lens 113 and is focused at the focal plane in the specimen A. Fluorescence is produced at the focal position of the laser light, and the fluorescence produced is collected by the objective lens 113, is transmitted through the dichroic mirror 121, is focused by the focusing lenses 118 and 119, and is detected by the light detector 115.

Because the fluorescence is produced only in an extremely shallow region in the vicinity of the focal plane of the objective lens 113, by storing the intensity of the fluorescence detected by the light detector 115 and the scanning position of the laser light scanned by the scanner 109 in association with each other, it is possible to obtain a fluorescence image (slice image) of the specimen A extending over the focal plane.

In the two-dimensional fluorescence image displayed on the monitor (not shown), the observer specifies the positions of the focal points where the laser light should be focused. For example, if the specimen A is a nerve cell whose behavior is to be observed when stimulated with laser light, the focal points where the stimulus is to be applied are distributed. In this case, the observer sets the two-dimensional positions of the focal points by specifying all focal points.

On the other hand, when the focal points are set to arbitrary positions in the specimen A, it is not necessary to acquire such a two-dimensional fluorescence image.

Reverse ray tracing is performed in the wavefront calculating section 124 using the position information set via the input section 123, as well as the lens data of each lens constituting the objective lens 113 and the refractive index of the specimen A stored in the storage section 122, and the wavefront at the entrance pupil position of the objective lens 113 is calculated for the laser light emitted from a point light source assumed at each focal point (step S102).

Once the wavefronts at the entrance pupil position of the objective lens 113 are calculated for all focal points, a linear summation of the wavefronts is calculated by the wavefront combining section 125, thus forming a combined wavefront (step S103). The combined wavefront thus formed is input to the phase-pattern setting section 126, and the phase pattern to be applied to the wavefront modulating device 112 is set to be identical to the combined wavefront at the entrance pupil position of the objective lens 113 or a pattern formed by phase-wrapping processing (step S104). Then, the phase pattern set by the phase-pattern setting section 126 is output to the wavefront modulating device 112.

This completes the preparations for performing observation while applying a light stimulus to the specimen A.

In this state, the microscope apparatus 103 is configured so that the mirror 117 is inserted into the light path (disposed at a position indicated by the solid lines in the figure), and the fluorescence collected by the objective lens 113 is focused by the focusing lens 120 and is acquired by the camera 116. Then, with the scanner 109 stopped at the origin, when the laser light emitted from the laser light source 105 is introduced into the wavefront modulating section 107, the wavefront of the laser light is modulated according to the phase pattern displayed on the wavefront modulating device 112. The modulated laser light passes through the relay lenses 108, the scanner 109, and the relay lenses 110, is reflected by the dichroic mirror 112, and enters the entrance pupil of the objective lens 113 (step S105).

Because the entrance pupil position of the objective lens 113 is located at a position that is optically conjugate with the wavefront modulating device 112, the laser light entering the entrance pupil position has a wavefront identical to the wavefront at the instant it is modulated by the wavefront modulating device 112.

Then, by focusing this laser light with the objective lens 113, a hologram image like one in which light is focused simultaneously at a plurality of focal points located at different positions can be projected inside the specimen A.

By simultaneously irradiating a plurality of specified focal points with the laser light, in the state where a stimulus is applied to the specimen A, the fluorescence emitted from the specimen A is collected by the objective lens 113, is transmitted through the dichroic mirror 121, is reflected by the mirror 117, is focused by the focusing lens 120, and is acquired by the camera 116. Thus, it is possible to obtain a fluorescence image of the specimen A while a light stimulus is applied thereto.

Thus, with the hologram-image projection apparatus 101 and the hologram-image projection method according to this embodiment, it is possible to focus laser light simultaneously at a plurality of sites of interest located at different positions in the specimen A. Consequently, when the focal points are set at positions responding to a light stimulus in the specimen A, an advantage is afforded in that it is possible to correctly observe the behavior of the specimen A occurring directly after the light stimulus without any time delay.

Note that, in this embodiment, although wavefront combining is performed in the wavefront combining section 125 by calculating a linear summation of the wavefronts, instead of this, it may be performed by arraying divided regions of the plurality of wavefronts calculated for individual focal points with a ratio equal to the reciprocal of the total number of focal points.

More specifically, if n is the total number of focal points, a linear summation of the wavefronts calculated for the individual focal points is not calculated, but the region on the wavefront modulating device 112 is divided, and any of the plurality of focal points are associated with the individual divided regions. The associating process here is preferably performed so that the regions associated with the individual focal points are periodically distributed with a ratio equal to the reciprocal of the total number of focal points, n. Also, the distribution of the regions associated with the individual focal points may be in the form of a mosaic or may be in form of concentric circles. Assuming this kind of association, in the wavefronts of the individual focal points which are calculated in advance, wavefront elements of portions of the wavefront modulating device 112 overlapping the associated regions are extracted, and the wavefronts are combined by arraying the extracted wavefront elements over the entire region. The phase pattern to be applied to the wavefront modulating device 112 is set on the basis of the combined wavefront obtained in this way.

With the hologram-image projection method of this embodiment, once the position information of each of the focal points located at different positions in the specimen A is set in the position setting step S101, in the wavefront calculating step S102, reverse ray tracing is performed from each focal point to the entrance pupil position of the objective lens 113, and a plurality of wavefronts at the entrance pupil position of the laser light are calculated from the individual focal points. By combining the plurality of calculated wavefronts in the wavefront combining step S103, a combined wavefront serving as the wavefront required to be incident at the entrance pupil position of the objective lens to simultaneously focus the laser light at different positions on the focal plane is obtained by calculation. Then, a phase pattern is applied to the wavefront modulating device 112 so that the wavefront of the laser light incident on the wavefront modulating device 112 is modulated to a wavefront identical to the obtained combined wavefront.

In this case, because reverse ray tracing is performed by using the lens data of the individual lenses constituting the objective lens 113 in addition to the position information of the individual focal points and the refractive index of the specimen, the calculated wavefront contains the effects of aberrations present in the objective lens 113. Therefore, by causing the laser light having this wavefront to be incident on the entrance pupil position of the objective lens 113 from the reflection side of the specimen, the laser light can be focused on the focal plane of the objective lens 113 with superior precision. Accordingly, by making the laser light incident on the wavefront modulating device 112 which is given a phase pattern that yields such a wavefront, a hologram image like one in which the laser light is focused simultaneously at a plurality of focal points on the focal plane of the objective lens 113 can be projected inside the specimen A.

With the hologram-image projection apparatus 101 of this embodiment, when the position information of the individual focal points located at different positions in the specimen A is set via the input section 123, reverse ray tracing from the focal points to the entrance pupil position of the objective lens 113 is performed by the wavefront calculating section 124, and a plurality of wavefronts at the entrance pupil position of the laser light are calculated from the individual focal points. By combining the plurality of calculated wavefronts with the wavefront combining section 125, a combined wavefront serving as the wavefront required to be incident at the entrance pupil position of the objective lens 113 to simultaneously focus the laser light at different positions on the focal plane is obtained by calculation. Then, the phase pattern is set by the phase-pattern setting section 126 on the basis of the combined wavefront obtained in this way.

In this case, because reverse ray tracing is performed by using the lens data of the individual lenses constituting the objective lens 113 in addition to the position information of the individual focal points and the refractive index of the specimen, the calculated wavefront contains the effects of aberrations present in the objective lens 113. Therefore, by causing laser light having this wavefront to be incident at the entrance pupil position of the objective lens from the reflection side of the specimen, the laser light can be focused on the focal plane of the objective lens with superior precision. Accordingly, by making the laser light incident on the wavefront modulating device 112 when a phase pattern that yields such a wavefront is applied to the wavefront modulating device 112, a hologram image like one in which laser light is focused simultaneously at a plurality of focal points on the focal plane of the objective lens 113 can be projected inside the specimen.

A hologram-image projection apparatus and hologram-image projection method according to a fourth embodiment of the present invention will be described below with reference to FIGS. 10, 11, 12A, and 12B.

In the third embodiment, the wavefront is created by performing reverse ray tracing from each of the set focal points to the entrance pupil position of the objective lens 113. In this embodiment, however, instead of this, a spot image is obtained by performing forward ray tracing from the entrance pupil position of the objective lens to each focal point, and the wavefront is created by minimizing the diameter of this spot.

As shown in FIG. 10, a hologram-image projection apparatus 200 according to this embodiment differs from the third embodiment in the configuration of a control apparatus 104. Specifically, the control apparatus 104 includes a storage section 122 that stores the lens data of the individual lenses constituting an objective lens 113 and the refractive index of a specimen A; an input section (position-information setting section) 123 for setting position information of the focal points of the laser light in the specimen A; a virtual-image creating section 127 that creates a virtual image having a plurality of spots formed at respective focal points by performing forward ray tracing from the entrance pupil position of the objective lens to the focal plane of the objective lens on the basis of the lens data of each constituent lens of the objective lens 113 and the refractive index of the specimen A stored in the storage section 122; a wavefront calculating section 128 that calculates the laser light wavefront at the entrance pupil position of the objective lens so that the diameter of the spots in the created virtual image is minimized; and a phase-pattern setting section 126 that sets the phase pattern to be applied to a wavefront modulating device 112 on the basis of the wavefront calculated by the wavefront calculating section 128.

Here, the forward ray tracing in the virtual-image creating section 127 is performed using the lens data of the individual constituent lenses of the objective lens 113 and the refractive index of the specimen A.

Also, the wavefront calculating section 128 performs calculations to vary the wavefront of the laser light at the entrance pupil position of the objective lens and calculates the diameters of the spots in the virtual image by forward ray tracing. Then, by repeating this operation, the wavefront calculating section 128 calculates the laser light wavefront that minimizes the diameters of the spots in the created virtual image.

A hologram-image projection method for projecting a hologram image like one in which laser light is focused simultaneously at a plurality of different positions in the specimen A by using the thus-configured hologram-image projection apparatus 200 according to this embodiment will be described.

First, as shown in FIG. 11, position information for each focal point on the focal plane of the objective lens is set via the input section 123 (step S111). When the focal points are set to positions that respond to a light stimulus in the specimen A, this is performed by specifying individual focal points in the slice image acquired at the focal plane of the objective lens via the input section 123.

Next, if it assumed that the objective lens 113 is aberration-free, a focal point map in which all focal points are focused at different positions on the focal plane of the objective lens 113 to form spots R is created in the input section 123 (step S112).

Incidentally, because aberrations actually exist in the objective lens 113, even if laser light for obtaining a hologram image like that shown in FIG. 12A is made incident by the aberration-free objective lens 113, in reality, one spot R1 is distorted due to aberrations and becomes larger, as shown in FIG. 12B. Thus, in the virtual-image creating section 127, the focal point map is Fourier transformed to calculate the wavefront of the laser light at the entrance pupil position of the objective lens 113 (step S113). Then, for laser light having the calculated wavefront at the entrance pupil position, forward ray tracing from the entrance pupil position of the objective lens 113 to the focal plane is performed in the virtual-image creating section 127 using the lens data of each lens constituting the objective lens 113 and the refractive index of the specimen A, to create the virtual image (step S114). During this process, the influence of the actual aberrations is reflected in the created virtual image, and the spot R1 is distorted due to the aberrations and becomes larger.

For each focal point forming the spot R1, the wavefront, at the entrance pupil position of the objective lens 113, of the laser light entering the objective lens 113 is repeatedly modified, and the wavefront that minimizes the spot diameter of the spot R1 is calculated (step S115). More specifically, as a metric for evaluating the spot diameter of each spot R1, Zernike polynomial coefficients are repeatedly varied, and the Zernike polynomial coefficients that minimize the spot diameter, serving as the evaluation metric, are identified.

Here, a cylindrical function w(r, θ) that gives the shape of the wavefront, which is a Zernike polynomial, is shown in the following expression:

$$w ( r , θ ) = Z 1 + Z 2 \cdot ρcos θ + Z 3 \cdot ρsinθ + Z 4 \cdot ( 2 {ρ}^{2} - 1 ) + Z 5 \cdot {ρ}^{2} cos 2 θ + Z 6 \cdot {ρ}^{2} sin 2 θ + Z 7 \cdot ( 3 {ρ}^{2} - 2 ) ρ cos θ + Z 8 \cdot ( 3 {ρ}^{2} - 2 ) ρsin θ …$$

Here, ρ is the distance from the center of the pupil normalized by the radius from the center of the entrance pupil of the objective lens 113, and θ is the angle relative to a prescribed reference line in polar coordinates in the plane of the wavefront modulating device 112 or the entrance pupil plane of the objective lens 113. Zn are Zernike coefficients.

The wavefront calculated in this way is input to the phase-pattern setting section 126, and the phase pattern to be applied to the wavefront modulating device 112 is set to be identical to the wavefront at the entrance pupil position of the objective lens 113 or a pattern formed by phase-wrapping processing (step S116). Then, the phase pattern set by the phase-pattern setting section 126 is output to the wavefront modulating device 112. In this state, when the laser light is emitted from the laser light source 105 and is introduced to the wavefront modulating section 7, the wavefront of the laser light is modulated according to the phase pattern on the wavefront modulating device 112. The modulated laser light passes through the relay lenses 108, the scanner 109, the relay lenses 110, and the dichroic mirror 121 and is focused onto the specimen by the objective lens 113 to irradiate it (step S117).

By doing so, because forward ray tracing is performed in the virtual-image creating section 127 by using the lens data of the individual lenses constituting the objective lens 113 in addition to the position information of the individual focal points and the refractive index of the specimen A, the spots in the created virtual image contain the influence of the aberrations existing in the objective lens 113. Therefore, by varying the Zernike polynomial coefficients so as to minimize the spot diameter of the spot R1 in which deformation occurs due to the aberrations, the wavefront at the entrance pupil position of the objective lens 113 is modulated to a wavefront in which the aberrations are anticipated in advance.

Therefore, by making laser light having such a wavefront incident at the entrance pupil position of the objective lens 113 from the opposite side of the specimen A, the wavefront is restored while being focused by the objective lens 113 and can be focused on the focal plane with superior precision. Therefore, by making the laser light incident on the wavefront modulating device 112 which has been given a phase pattern that yields such a wavefront, a hologram image like one in which laser light is focused simultaneously at a plurality of focal points on the focal plane of the objective lens 113 can be projected in the specimen A.

In this embodiment, although a segmented MEMS mirror whose surface shape can be varied has been illustrated as an example of the wavefront modulating device 112, instead of this, any other type of wavefront modulating device 112 can be used, for example, a liquid crystal device, a deformable mirror, or the like. In the case of a liquid crystal device, the refractive index distribution due to the alignment of the liquid crystal molecules constitutes the phase pattern, and in the case of a deformable mirror, the surface shape thereof constitutes the phase pattern.

With the hologram-image projection method of this embodiment, once the position information of the individual focal points disposed at different positions in the specimen is set in the position setting step S111, in the virtual-image creating step S114, forward ray tracing is performed from the entrance pupil position of the objective lens to the focal plane, and a virtual image having a plurality of spots formed at the individual focal points is created. Then, in the wavefront calculating step S115, the laser light wavefront at the entrance pupil position of the objective lens 113 is calculated so that the diameters of the individual spots in the created virtual image are minimized. Then, a phase pattern is applied to the wavefront modulating device 112 on the basis of the wavefront calculated in the wavefront calculating step S115 so that the wavefront of the laser light incident on the wavefront modulating device 112 is modulated to a wavefront identical to the obtained wavefront.

In this case, because the forward ray tracing is performed using the lens data of the individual lenses constituting the objective lens 113, in addition to the position information of each focal point and the refractive index of the specimen, the individual spots in the created virtual image contain the influence of the aberrations present in the objective lens 113. Therefore, by making laser light having a wavefront that minimizes the diameters of the individual spots incident at the entrance pupil position of the objective lens 113 from the opposite site of the specimen, the laser light is focused on the focal plane of the objective lens 113 with superior precision. Therefore, by introducing laser light to the wavefront modulating device 112 which is given a phase pattern that yields such a wavefront, a hologram image like one in which laser light is focused simultaneously at a plurality of focal points on the focal plane of the objective lens 113 can be projected inside the specimen.

A hologram-image projection apparatus according to a fifth embodiment of the present invention will be described below with reference to the drawings.

As show in FIG. 13, a hologram-image projection apparatus 201 according to this embodiment, which is a microscope system, includes a light source apparatus 202 that emits laser light, a microscope apparatus 203 that irradiates a specimen A with the laser light incident from the light source apparatus 202, and a control apparatus 204 that controls the laser light incident on the microscope apparatus 203 from the light source apparatus 202.

The light source apparatus 202 includes a laser light source 205 that emits laser light, a collimator lens 206 that converts the laser light emitted from the laser light source 205 into a collimated beam, a wavefront modulating section 207 that modulates the wavefront of the collimated laser light, relay lenses 208 and 210, and a scanner (incident-angle adjusting section) 209 that scans the laser light.

The wavefront modulating section 207 includes a prism 211 that reflects the laser light and a reflective wavefront modulating device 212 that reflects the laser light reflected by the prism 211, during which time the wavefront of the laser light is modulated by a phase pattern, and returns the modulated laser light to the prism 211.

The laser light reflected by the prism 211 has its light path folded at the wavefront modulating device 212 so as to return to the same prism 211, and then returns to a light path on the same axis as the laser light from the laser light source 205.

The wavefront modulating device 212 is formed of a segmented MEMS mirror whose surface shape can be arbitrarily changed by the control apparatus 204, described later. In this case, the surface shape formed by the indentations and protrusions of the individual segments of the MEMS mirror constitutes the phase pattern for modulating the wavefront of the laser light. The wavefront modulating device 212 and the entrance pupil position of an objective lens 213 are disposed in an optically conjugate positional relationship.

The scanner 209 is a so-called proximity galvanometer mirror in which two galvanometer mirrors 209a and 209b that can be swiveled about axes disposed in mutually intersecting directions are placed in close proximity to each other, so that the incident laser light can be scanned two-dimensionally.

The microscope apparatus 203 includes the objective lens 213, which focuses the laser light onto the specimen A, disposed on a stage 214, and also collects light coming from the specimen A; a light detector 215, formed of a photomultiplier tube, for detecting the light collected by the objective lens 213; a camera 216, such as a CCD, that captures a fluorescence image in the specimen A; and a mirror 217 that is inserted in and removed from the light path so as to switch the light path to either the light detector 215 or the camera 216. Reference numerals 218 to 220 are focusing lenses, and reference numeral 221 is a dichroic mirror. The objective lens 213 is provided in such a manner that the distance between the objective lens 213 and the stage 214 in the optical axis direction can be varied.

By setting the surface shape of the wavefront modulating device 212 to a flat reflective surface shape, it is possible to make laser light having a plane-wave wavefront incident at the entrance pupil position of the objective lens 213. Accordingly, it is possible to focus the laser light at the focal plane of the objective lens 213.

With the mirror 217 switched to the light detector 215 side (a position where it is removed from the light path, as indicated in the dotted lines), the laser light is emitted from the laser light source 205, and while the laser light focused at the focal plane in the specimen A is two-dimensionally scanned by driving the scanner 209, fluorescence produced at each focal position is detected by the light detector 215, thereby enabling acquisition of a two-dimensional fluorescence image of the specimen A extending over the focal plane of the objective lens 213.

Then, by acquiring a plurality of two-dimensional fluorescence images (slice images) while changing the position of the focal plane of the objective lens 213 by changing the relative distance between the objective lens 213 and the stage 214, it is possible to acquire a three-dimensional fluorescence image of the specimen A.

As shown in FIG. 13, the control apparatus 204 includes an input section (focal position setting section) 222 for setting position information of the laser light at the specimen A; a control unit 224 that controls the scanner 209 and the optical-path-length adjusting prism 223, described later, on the basis of the position information of the individual focal points set via the input section 222; a wavefront setting section 225 that measures the wavefront of return light from the individual focal points at positions set via the input section 222; a wavefront combining section 226 that combines a plurality of wavefronts of the return light, measured for all focal points; and a phase-pattern setting section 227 that sets a phase pattern to be applied to the wavefront modulating device 212 on the basis of the combined wavefront combined by the wavefront combining section 226.

The input section 222 sets the position information of each focal point by the observer specifying the positions where the laser light is desired to be focused, that is to say, the focal points, on a monitor (not illustrated).

Here, the focal points on the specimen A may be set to arbitrary positions, or they may be set to position that respond to a light stimulus. When the focal points are desired to be set to positions that respond to a light stimulus, it is preferable to display the image acquired by the microscope apparatus 203 on the monitor (not illustrated) so as to make is easier for the observer to specify the focal points.

The wavefront measuring section 225 includes a polarizing beam splitter (splitting section) 228, disposed in front of the wavefront modulating section 207, for splitting the laser light into reference light and measurement light; a polarizing beam splitter 231, disposed after the wavefront modulating section 207 which is provided in a measurement light path 229 along which the measurement light travels, for combining the returning measurement light from the specimen A and the reference light coming via the reference light path 230; a wave plate 232 that rotates the polarization direction of the laser light, which is converted to a collimated beam by the collimator lens 206, by an arbitrary angle; a wave plate 233 that converts the laser light (measurement light) transmitted through the polarizing beam splitter 231 into circularly polarized light or rotates it by 45°; and a detection light path 234 for detecting the reference light and the return light combined by the polarizing beam splitter 231.

The wave plate 232 is placed so as to rotate the polarization direction of the laser light, so that the laser light is split at the polarizing beam splitter 228 into the reference light and the measurement light at a prescribed intensity ratio. The wave plate 233 is disposed so as to rotate the polarization direction by 90° in the section where the measurement light transmitted through the polarizing beam splitter 231 is focused at the specimen A and then return light from the specimen A re-enters the polarizing beam splitter 231.

An optical-path-length adjusting prism 223 that is provided so as to be movable along the optical axis to adjust the optical path length, a dispersion-compensation plate 235 that compensates for group velocity dispersion, and a half-wave plate 236 that rotates the polarization direction of the reference light entering the polarizing beam splitter 231 by 90° are disposed in the reference light path 230. Reference numeral 237 is a mirror.

A polarizing plate 238 that transmits the return light passing through the wave plate 233 and the reference light passing through the half-wave plate 236 with a prescribed intensity ratio; relay lenses 239 that relay the pupil; and an interference-light detector 240 that detects the interference light generated by combining the return light and the reference light are disposed in the detection light path 234.

Because the polarization directions of the return light passing through the wave plate 233 and the reference light passing through the half-wave plate 236 are substantially orthogonal to each other, the polarizing plate 238 has a transmission axis forming an angle greater than 0 relative to the polarization directions of the respective beams. Accordingly, the polarizing plate 238 transmits only components of the return light and the reference light oriented along a prescribed axis.

The interference-light detector 240 is disposed so as to have an optically conjugate positional relationship with the wavefront modulating device 212 and the entrance pupil position of the objective lens 213.

The wavefront combining section 226 is configured to combine the wavefronts measured for all of the focal points. In this embodiment, the wavefront combining section 226 is configured to calculate the linear summation of the wavefronts calculated for all of the focal points.

The phase-pattern setting section 227 sets the phase pattern to be applied to the wavefront modulating device 212 on the basis of the combined wavefront calculated by the wavefront combining section 226 and outputs it to the wavefront modulating device 212. Here, because the wavefront modulating device 212 has a conjugate relationship with the entrance pupil of the objective lens 213, the phase pattern applied to the wavefront modulating device 212 is identical to the combined wavefront at the entrance pupil position of the objective lens 213 or a pattern formed by phase-wrapping processing. In phase-wrapping processing, when the range of phase modulation at the wavefront modulating device 212 is set to 2 nπ (n is an integer), for portions in the combined wavefront at the entrance pupil position of the objective lens 213 that have a phase difference exceeding 2 nπ, 2 nπ is subtracted from that phase difference. With the segmented MEMS mirror in this embodiment, because the range of phase modulation is normally set to a range of 2 nπ, phase-wrapping processing is performed as required.

In this way, the wavefront modulating device 212 is adjusted to a shape matching the input phase pattern. Thus, the laser light reflected at the wavefront modulating device 212 is modulated at the surface of the wavefront modulating device 212 to have the same wavefront as the combined wavefront obtained at the entrance pupil position of the objective lens 213. Therefore, by focusing this laser light with the objective lens 213, it is simultaneously focus it at the individual set focal points while keeping the objective lens 213 fixed.

The operation of the thus-configured hologram-image projection apparatus 201 according to this embodiment will be described below.

First, the position information of the individual focal points is set via the input section 222.

Here, when the focal point is set to a position in the specimen A that responds to a light stimulus, the wavefront modulating device 212 is set to a phase pattern that gives a flat reflecting surface shape, based on the output from the control apparatus 204. In the microscope apparatus 203, the mirror 217 is retracted from the light path. Then, laser light is emitted from the laser light source 205, and the laser light is two-dimensionally scanned by the scanner 209.

The laser light emitted from the laser light source 205 propagates along the light path without changing its wavefront and, after being two-dimensionally scanned by the scanner 209, is reflected by the dichroic mirror 221 to enter the objective lens 213 and is focused at the focal plane in the specimen A. Fluorescence is produced at the focal position of the laser light, and the fluorescence produced is collected by the objective lens 213, is transmitted through the dichroic mirror 221, is focused by the focusing lenses 219 and 220, and is detected by the light detector 215.

Because the fluorescence is produced only in an extremely shallow region in the vicinity of the focal plane of the objective lens 213, by storing the intensity of the fluorescence detected by the light detector 215 and the scanning position of the laser light scanned by the scanner 209 in association with each other, it is possible to obtain a two-dimensional fluorescence image (slice image) of the specimen A extending over the focal plane.

Also, a three-dimensional fluorescence image can be obtained by acquiring a plurality of slice images while moving the objective lens 213 and the specimen A relative to each other in the optical axis direction.

On the two-dimensional or three-dimensional fluorescence image displayed on the monitor (not shown), the observer specifies the position of focal points where the laser light is desired to be focused. For example, if the specimen A is a nerve cell whose behavior is to be observed when stimulated with laser light, the focal points where the stimulus is to be applied are distributed three-dimensionally. In this case, the observer sets the three-dimensional position information of the focal points by specifying all focal points.

Next, wavefront measurement is performed in the wavefront measuring section 225 for the individual set focal points.

Specifically, the control unit 224 operates the scanner 209 on the basis of the position coordinates of each of the focal points set via the input section and irradiates the focal points with laser light one-by-one. During this process, the control unit 224 adjusts the position of the optical-path-length adjusting prism 223 so that the optical path length of the reference light path 230 matches the optical path length of the measurement light path 229 to the individual focal points set via the input section 222. Also, during this process, the wavefront modulating device 212 is set to a phase pattern giving a flat reflective surface shape.

Laser light having, for example, a vertical polarization plane emitted from the laser light source 205 is made to pass through the wave plate 232, thereby rotating the polarization direction thereof by a prescribed angle, and then enters the polarizing beam splitter 228. At the polarizing beam splitter 228, the light is split into two, a vertically polarized component and a horizontally polarized component, one of which, for example, the vertically polarized component, is introduced to the reference light path 230, and the other of which is introduced to the measurement light path 229.

The vertically polarized component directed to the reference light path 230 is subjected to dispersion compensation upon passing through the dispersion-compensation plate 235, and after being folded at the optical-path-length adjusting prism 223, the polarization direction is rotated by 90° by the half-wave plate 236 to become a horizontally polarized component. The laser light from the reference light path 230, which has become the horizontally polarized component, is transmitted through the polarizing beam splitter 231 and is introduced to the detection light path 234.

On the other hand, the horizontally polarized component transmitted through the polarizing beam splitter 228 enters the measurement light path 229 and, after being reflected at the prism 211 and the wavefront modulating device 212, is transmitted through the polarizing beam splitter 231 and passes through the wave plate 233. Accordingly, the laser light that has been converted to circularly polarized light or had its polarization direction rotated by 45° passes through the relay lenses 208 and is then given an angle for directing it to a desired focal point by the scanner 209. Then, after being transmitted through the relay lenses 210, the light enters the microscope apparatus 203.

The laser light that has entered the microscope apparatus 203 is reflected by the dichroic mirror 221 and is focused at the specimen A by the objective lens 213. The laser light reflected at a region in the vicinity of the focal point in the specimen A is collected by the objective lens 213, and is then reflected by the dichroic mirror 221, returns via the relay lenses 210, the scanner 209, and the relay lenses 208, is converted to a vertically polarized component by the wave plate 233, and enters the polarizing beam splitter 231.

The laser light formed of the vertically polarized component entering the polarizing beam splitter 231 is reflected by the polarizing beam splitter 231 and enters the detection light path 234. At this time, the laser light formed of the vertically polarized component is combined with the laser light formed of the horizontally polarized component coming via the reference light path 230. Then, in the laser light formed of the vertically polarized component, which is the return light from the specimen A, and the laser light formed of the horizontally polarized component, which is the reference light, only the components parallel to the transmission axis of the polarizing plate 238 are transmitted through the polarizing plate 238 and are incident on the interference-light detector 240 via the relay lenses 239. Because the return light and the reference light transmitted through the polarizing plate 238 have the same polarization direction, interference between the return light and the reference light is possible. Also, because the optical path length of the reference light path 230 and the optical path length of the measurement light path 229 up to the focal point are made the same by the optical-path-length adjusting prism 223, only the return light returning from the focal point interferes with the reference light.

Accordingly, the differences between the wavefront of the laser light emitted from the laser light source 205 and the wavefront of the laser light which is return light from the focal point are detected at the interference-light detector 240 as an interference pattern.

Once the wavefronts are detected by performing the above-described operation for all focal points, the linear summation of the wavefronts measured for the individual focal points is calculated by the wavefront combining section 226, and the combined wavefront is created. The created combined wavefront is input to the phase-pattern setting section 227, and the phase pattern to be applied to the wavefront modulating device 212 is set so as to be identical to the combined wavefront at the entrance pupil position of the objective lens or a pattern obtained by phase-wrapping processing. Then, the phase pattern set by the phase-pattern setting section 227 is output to the wavefront modulating device 212.

This completes the preparations for observing the specimen A while performing optical stimulation.

In this state, the microscope apparatus 203 is configured so that the mirror 217 is inserted into the light path (disposed at a position indicated by the solid lines in the figure), and the fluorescence collected by the objective lens 213 is acquired by the camera 216. Then, with the scanner 9 stopped at the origin, when the laser light emitted from the laser light source 205 is introduced into the wavefront modulating section 207, the wavefront of the laser light is modulated according to the phase pattern displayed on the wavefront modulating device 212. The modulated laser light passes through the relay lenses 208, the scanner 209, and the relay lenses 210, is reflected by the dichroic mirror 221, and enters the entrance pupil of the objective lens 213.

Because the entrance pupil position of the objective lens 213 is located at a position that is optically conjugate with the wavefront modulating device 212, the laser light incident at the entrance pupil position has a wavefront identical to the wavefront at the instant it is modulated by the wavefront modulating device 212.

Then, by focusing this laser light with the objective lens 213, a three-dimensional hologram image like one in which light is focused simultaneously at a plurality of focal points located at different positions can be projected inside the specimen A.

By simultaneously irradiating a plurality of specified focal points with the laser light, in the state where a stimulus is applied to the specimen A, the fluorescence emitted from the specimen A is collected by the objective lens 213, is transmitted through the dichroic mirror 221, is reflected by the mirror 217, is focused by the focusing lens 218, and is acquired by the camera 216. Thus, it is possible to obtain a fluorescence image of the specimen A while a light stimulus is applied thereto.

Thus, with the hologram-image projection apparatus 201 according to this embodiment, because the wavefront of the laser light is adjusted so that the combined wavefront formed by combining the wavefronts obtained by measuring the return light from the point light sources disposed at all focal points is incident at the entrance pupil position of the objective lens 213, it is possible to focus the laser light at a plurality of focal points simultaneously with superior precision to apply a light stimulus to the specimen A. As a result, when the focal points are set at positions in the specimen that respond to a light stimulus, an advantage is afforded in that it is possible to correctly observe the behavior of the specimen A occurring directly after the light stimulus without any time delay.

In this case, according to this embodiment, because the wavefronts corresponding to the individual focal points are obtained by measurement, even in the presence of various aberrations whose cause cannot be ascertained, an advantage is afforded in that they can be sufficiently compensated for without identifying their cause, and the laser light can be focused with superior precision at the individual focal points.

In this embodiment, a device of the type in which the laser light is divided into reference light and measurement light, the reference light and the return light are made to interfere by making the optical path length of the measurement light path 229 match that of the reference light path 230, and the wavefront is measured is employed as the wavefront measuring section 225; however, as shown in FIG. 14, a device of the type in which a confocal pinhole (pinhole member) 241 and a Hartmann sensor 242 are combined may be used instead.

That is, in the example shown in FIG. 14, the polarizing beam splitter 228 and the reference light path 230 are eliminated, and instead, the confocal pinhole is disposed in the detection light path 234, and a 2 Hartmann sensor 242 is employed instead of the interference-light detector 240. By disposing the confocal pinhole at a position that is optically conjugate with the focal position of the objective lens 213, it is possible to detect, with the Hartmann sensor 242, only the return light from a point light source disposed at the focal position and to measure the wavefront.

In this figure, the wave plate 232 is an element for rotating the polarization plane so that the polarization direction of the laser light emitted from the laser light source 205 matches the polarization direction that can be transmitted through the polarizing beam splitter 231.

In this embodiment, the wavefront combining in the wavefront combining section 226 is performed by calculating the linear summation of the wavefronts; instead of this, however, it may be performed by arraying divided regions of the plurality of wavefronts calculated for the individual focal points with a ratio equal to the reciprocal of the total number of focal points.

More specifically, if n is the total number of focal points, a linear summation of the wavefronts calculated for the individual focal points is not calculated, but the region on the wavefront modulating device 212 is divided, and any of the plurality of focal points are associated with the individual divided regions. The associating process here is preferably performed so that the regions associated with the individual focal points are periodically distributed with a ratio equal to the reciprocal of the total number of focal points, n. Also, the distribution of the regions associated with the individual focal points may be in the form of a mosaic or may be in form of concentric circles. Assuming this kind of association, in the wavefronts from the individual focal points which are calculated in advance, wavefront elements of portions of the wavefront modulating device 212 overlapping the associated regions are extracted, and the wavefronts are combined by arraying the extracted wavefront elements over the entire region. The phase pattern to be applied to the wavefront modulating device 212 is set on the basis of the combined wavefront obtained in this way.

Furthermore, in this embodiment, although a segmented MEMS mirror whose surface shape can be varied has been illustrated as an example of the wavefront modulating device 212, instead of this, any other type of wavefront modulating device 212 can be used, for example, a liquid crystal device, a deformable mirror, or the like. In the case of a liquid crystal device, the refractive index distribution due to the alignment of the liquid crystal molecules constitutes the phase pattern, and in the case of a deformable mirror, the surface shape thereof constitutes the phase pattern.

With the hologram-image projection apparatus 201 of this embodiment, when the laser light emitted from the laser light source is radiated onto the specimen A, the wavefronts, at the entrance pupil position, of the return light returning from the individual focal points at the positions set via the input section 222 are measured by the wavefront measuring section 225. Once the wavefronts are measured, the wavefront combining section 226 calculates the combined wavefront by combining the plurality of measured wavefronts corresponding to the individual focal points, and the phase-pattern setting section 227 sets the phase pattern to be applied to the wavefront modulating device 212 on the basis of the calculated combined wavefront and outputs this phase pattern to the wavefront modulating device 212. Then, by making laser light incident on the wavefront modulating device 212 with the set phase pattern applied to the wavefront modulating device 212, laser light having the combined wavefront is made incident at the entrance pupil position of the objective lens 213, and a hologram image including a plurality of focal points is projected inside the specimen A.

In this case, with the hologram-image projection apparatus 201 according to this embodiment, because the phase pattern for focusing the laser light at the focal points is set by measuring the wavefronts of return light from a plurality of focal points that actually exist, even when causes of various aberrations coexist, the laser light can be focused simultaneously at a plurality of desired focal points in the specimen.

According to this embodiment, by splitting the laser light with the polarizing beam splitter 228, one laser beam is directed to the specimen to irradiate the specimen, while the other laser beam serves as reference light. Then, the reference light and the return light from point light sources disposed at focal points set in the specimen A are made to interfere by combining them with the polarizing beam splitter 231, and the interference light thereof is detected by the interference-light detector 240. Accordingly, because minute differences in the wavefronts of the reference light and the return light from the specimen are detected by the interference-light detector 240, the laser light wavefront for focusing the laser light at the focal point can be precisely measured as the differences relative to the reference light.

Also, of the return light returning from the specimen as a result of irradiating the specimen with laser light, only the return light emitted from the focal position of the objective lens is selected by the confocal pinhole 241 and can be detected by the Hartmann sensor 242. Thus, it is possible to accurately measure the wavefront of the return light from a point light source disposed at the focal position of the objective lens 213.

### REFERENCE SIGNS LIST

A specimen
Δd prescribed distance
P focal point
Q reference plane
R, R1, R2 spot
ΔZ change in vector information
S1, S11 step of setting position information
S2 step of calculating laser light wavefront at entrance pupil position
S3 step of calculating combined wavefront
S4, S16 step of setting phase pattern
S5 step of focusing laser light a specimen
S12 step of creating first virtual image
S14 step of creating second virtual image
1, 100 hologram-image projection apparatus
12 wavefront modulating device
13 objective lens
23 input section (position-information setting section)
24 wavefront calculating section
25 wavefront combining section
26 phase-pattern setting section
S101, S111 step of setting position
S102, S115 step of calculating wavefront at entrance pupil position
S103 step of calculating combined wavefront
S104, S116 step of setting phase pattern
S105, S117 step of focusing modulated laser light at specimen
S112 step of creating focal point map
S114 step of creating virtual image
101 hologram-image projection apparatus
112 wavefront modulating device
113 objective lens
123 input section (position-information setting section)
124 wavefront calculating section
125 wavefront combining section
126 phase-pattern setting section
201 hologram-image projection apparatus
205 laser light source
209 scanner (incident-angle adjusting section)
212 wavefront modulating device
213 objective lens
222 input section (focal-position setting section)
225 wavefront measuring section
226 wavefront combining section
227 phase-pattern setting section
231 polarizing beam splitter (combining section)
240 interference-light detector
241 confocal pinhole (pinhole member)
242 Hartmann sensor

1. A hologram-image projection method comprising:
a position setting step of setting three-dimensional position information in a specimen for a plurality of focal points where laser light is to be focused via an objective lens;
a wavefront calculating step of performing reverse ray tracing from the individual focal points assumed at set positions to an entrance pupil position of the objective lens by using the position information set for the individual focal points in the specimen, a refractive index of the specimen, and overall characteristic data of the objective lens, to calculate wavefronts of the laser light at the entrance pupil position from the individual focal points;
a wavefront combining step of calculating a combined wavefront by combining the plurality of wavefronts calculated for the individual focal points;
a phase-pattern setting step of setting a phase pattern to be applied to a wavefront modulating device on the basis of the calculated combined wavefront; and
a focusing step of applying the set phase pattern to the wavefront modulating device, causing the laser light to be incident thereon, and focusing the laser light whose wavefront is modulated by the phase pattern on the specimen via the objective lens.

2. A hologram-image projection method according to claim 1, wherein the wavefront combining step is a step of calculating the combined wavefront by calculating a linear summation of the plurality of wavefronts.

3. A hologram-image projection method according to claim 1, wherein the wavefront combining step is a step of calculating the combined wavefront by arraying respective divided regions of the plurality of wavefronts with a ratio equal to the reciprocal of the number of focal points.

4. A hologram-image projection method comprising:
a position setting step of setting three-dimensional position information in a specimen for a plurality of focal points where laser light is to be focused via an objective lens;
a virtual-image creating step of creating a virtual image in which the individual focal points are projected on a prescribed reference plane in the specimen using the set position information of the individual focal points in the specimen;
a wavefront calculating step of calculating a wavefront of the laser light at an entrance pupil position of the objective lens by Fourier transforming the created virtual image using the refractive index of the specimen and overall characteristic data of the objective lens;
a phase-pattern setting step of setting a phase pattern to be applied to a wavefront modulating device on the basis of the calculated wavefront; and
a focusing step of applying the set phase pattern to the wavefront modulating device, causing the laser light to be incident thereon, and focusing the laser light whose wavefront is modulated by the phase pattern on the specimen via the objective lens.

5. A hologram-image projection method according to claim 4, wherein:
the position setting step includes a plane position setting step of setting plane position information in the specimen for the plurality of focal points, and a depth-information setting step of setting depth information relative to the reference plane for the individual focal points;
the virtual-image creating step includes a first-virtual-image creating step of creating a first virtual image for when it is assumed that the individual focal points are focused on a prescribed reference plane in the specimen to form a plurality of spots, by using the plane position information in the specimen for the individual focal points, and a second-virtual-image creating step of creating a second virtual image by correcting a corresponding spot in the first virtual image on the basis of the set depth information of the individual focal points.

6. A hologram-image projection method according to claim 5, wherein the second-virtual-image creating step is a step of correcting the corresponding spot in the first virtual image by substituting the spot in the first virtual image with a spots of the laser light obtained by ray tracing the laser light focused at the individual focal points up to the reference plane.

7. A hologram-image projection method according to claim 5, wherein the second-virtual-image creating step includes a step in which, with the objective lens disposed so that a focal position of the objective lens is displaced from the reference plane by a prescribed distance in the optical axis direction, a coefficient of proportionality is calculated by dividing a change in vector information, occurring when vector information representing aberrations at a focal plane of the objective lens varied, by the prescribed distance so that light is focused at the reference plane, and a step of correcting the spots using vector information obtained by multiplying the coefficient of proportionality and the depth information for each spot.

8. A hologram-image projecting apparatus comprising:
a wavefront modulating device that modulates a wavefront of laser light with a phase pattern;
an objective lens that focuses the laser light modulated by the wavefront modulating device on a specimen;
a position-information setting section for setting three-dimensional position information in the specimen for a plurality of focal points where the laser light is to be focused via the objective lens;
a wavefront calculating section that performs reverse ray tracing from the individual focal points assumed at set positions to an entrance pupil position of the objective lens by using the position information, inside the specimen, set for the individual focal points by the position-information setting section, a refractive index of the specimen, and overall characteristic data of the objective lens, to calculate wavefronts of the laser light at the entrance pupil position from the individual focal points;
a wavefront combining section that calculates a combined wavefront by combining the plurality of wavefronts calculated by the wavefront calculating section for the individual focal points; and
a phase-pattern setting section that sets the phase pattern to be applied to the wavefront modulating device on the basis of the calculated combined wavefront.

9. A hologram-image projecting apparatus comprising:
a wavefront modulating device that modulates a wavefront of laser light with a phase pattern;
an objective lens that focuses the laser light modulated by the wavefront modulating device on a specimen;
a position-information setting section for setting three-dimensional position information, inside the specimen, for a plurality of focal points where the laser light is to be focused via the objective lens;
a virtual-image creating section of creating a virtual image in which the individual focal points are projected on a prescribed reference plane in the specimen by using the position information, inside the specimen, set for the individual focal points by the position-information setting section;
a wavefront calculating section that calculates a wavefront of the laser light at an entrance pupil position of the objective lens by Fourier transforming the virtual image created by the virtual-image creating section using a refractive index of the specimen and overall characteristic data of the objective lens; and
a phase-pattern setting section that sets the phase pattern to be applied to the wavefront modulating device on the basis of the calculated wavefront.

10. A hologram-image projection method comprising:
a position setting step of setting, for a plurality of focal points where laser light is to be focused via an objective lens, position information on a focal plane of the objective lens in the specimen;
a wavefront calculating step of performing reverse ray tracing from the individual focal points assumed at set positions to an entrance pupil position of the objective lens by using the position information, in the specimen, set for the individual focal points, a refractive index of the specimen, and lens data of individual lenses constituting the objective lens, to calculate wavefronts of the laser light at the entrance pupil position from the individual focal points;
a wavefront combining step of calculating a combined wavefront by combining the plurality of wavefronts calculated for the individual focal points;
a phase-pattern setting step of setting a phase pattern to be applied to a wavefront modulating device on the basis of the calculated combined wavefront; and
a focusing step of applying the set phase pattern to the wavefront modulating device, causing the laser light to be incident thereon, and focusing the laser light whose wavefront is modulated by the phase pattern on the specimen via the objective lens.

11. A hologram-image projection method according to claim 10, wherein the wavefront combining step is a step of calculating the combined wavefront by calculating a linear summation of the plurality of wavefronts.

12. A hologram-image projection method according to claim 10, wherein the wavefront combining step is a step of calculating the combined wavefront by arraying respective divided regions of the plurality of wavefronts with a ratio equal to the reciprocal of the number of focal points.

13. A hologram-image projection method comprising:
a position setting step of setting, for a plurality of focal points where laser light is to be focused via an objective lens, position information on a focal plane of the objective lens in the specimen;
a virtual-image creating step of creating a virtual image having a plurality of spots formed at the individual focal points, by performing forward ray tracing from an entrance pupil position of the objective lens to the focal plane using the position information, in the specimen, set for the individual focal points, a refractive index of the specimen, and lens data of individual lenses constituting the objective lens;
a wavefront calculating step of calculating the wavefront so that, by varying the wavefront of the laser light at the entrance pupil position of the objective lens, the diameters of the individual spots in the created virtual image are minimized;
a phase-pattern setting step of setting a phase pattern to be applied to a wavefront modulating device on the basis of the calculated wavefront; and
a focusing step of applying the set phase pattern to the wavefront modulating device, causing the laser light to be incident thereon, and focusing the laser light whose wavefront is modulated by the phase pattern on the specimen via the objective lens.

14. A hologram-image projection method according to claim 13, wherein
the position information is a focal-point map including the plurality of focal points, which are assumed to be on the focal plane of the objective lens in the specimen;
the virtual-image creating step includes a step of calculating the wavefront of the laser light at the entrance pupil position of the objective lens by Fourier transforming the focal-point map, and a step of creating the virtual image by performing forward ray tracing from the entrance pupil position of the objective lens to the focal plane, for the laser light having the calculated wavefront, by using the refractive index of the specimen and the lens data of the individual lenses constituting the objective lens.

15. A hologram-image projecting apparatus comprising:
a wavefront modulating device that modulates a wavefront of laser light with a phase pattern;
an objective lens that focuses the laser light modulated by the wavefront modulating device on a specimen;
a position-information setting section for setting, for a plurality of focal points on a focal plane where laser light is to be focused via an objective lens, position information on the focal plane of the objective lens in the specimen;
a wavefront calculating section that performs reverse ray tracing from the individual focal points assumed at the set positions to an entrance pupil position of the objective lens by using the position information of the individual focal points set by the position-information setting section, a refractive index of the specimen, and lens data of individual lenses constituting the objective lens to calculate wavefronts of the laser light at the entrance pupil position from the individual focal points;
a wavefront combining section that calculates a combined wavefront by combining the plurality of wavefronts calculated for the individual focal points; and
a phase-pattern setting section that sets the phase pattern to be applied to the wavefront modulating device on the basis of the calculated combined wavefront.

16. A hologram-image projection apparatus comprising:
a laser light source;
a wavefront modulating device that modulates a wavefront of laser light emitted from the laser light source with a phase pattern;
an objective lens that focuses the laser light on a specimen;
an incident-angle adjusting section that adjusts an incident angle of the laser light at the entrance pupil position of the objective lens;
a focal-position setting section that sets the positions of a plurality of focal points where the laser light is to be focused in the specimen;
a wavefront measuring section that measures wavefronts, at the entrance pupil position of the objective lens, or a position optically conjugate therewith, for return light returning from the individual focal points at the positions set by the focal-position setting section;
a wavefront combining section that calculates a combined wavefront by combining the plurality of wavefronts of the return light measured by the wavefront measuring section; and
a phase-pattern setting section that sets the phase pattern to be applied to the wavefront modulating device on the basis of the calculated combined wavefront and outputs the phase pattern to the wavefront modulating device.

17. A hologram-image projection apparatus according to claim 16, wherein the wavefront combining section calculates the combined wavefront by calculating a linear summation of the plurality of return light wavefronts measured by the wavefront measuring section.

18. A hologram-image projection apparatus according to claim 16, wherein the wavefront combining section calculates the combined wavefront by arraying respective divided regions of the plurality of return light wavefronts measured by the wavefront measuring section with a ratio equal to the reciprocal of the number of focal points.

19. A hologram-image projection apparatus according to claim 16, wherein the wavefront measuring section includes a splitting portion that generates reference light by splitting the laser light; a combining section that combines the reference light and the return light from the focal point; and an interference-light detector that detects interference light of the return light and the reference light combined by the combining section.

20. A hologram-image projection apparatus according to claim 16, wherein the wavefront measuring section includes a pinhole member disposed at a position that is optically conjugate with the focal position of the objective lens; and a Hartmann sensor that detects the return light from the focal point, which has passed through the pinhole member.
